(19) United States
(12) Patent Application Publication
(10) Pub. No.: US 2012/0021346 A1
(43) Pub. Date: Jan. 26, 2012

(54) IMAGE BEARING MEMBER AND IMAGE FORMING METHOD, IMAGE FORMING APPARATUS, AND PROCESS CARTRIDGE USING SAME

(76) Inventors: Norio Nagayama, Shizuoka (JP); Yuuji Tanaka, Shizuoka (JP); Hiromi Sakaguchi, Kanagawa (JP); Tetsuro Suzuki, Shizuoka (JP); Tatsuya Niimi, Shizuoka (JP)

(21) Appl. No.: 13/181,149

(22) Filed: Jul. 12, 2011

(30) Foreign Application Priority Data
Jul. 21, 2010 (JP) 2010-163847

(51) Int. Cl. G03G 15/00; G03G 21/18

(52) U.S. Cl. 430/56; 399/111; 430/73; 430/57.1; 430/124.1; 399/159

(57) ABSTRACT

An image bearing member having a substrate and a layer provided overlying the substrate, which has a cured material in which a compound comprising three or more methylol groups and a charge transport group is cross-linked.

### BACKGROUND OF THE INVENTION

1. Field of the Invention

The present invention relates to an image bearing member (also known as a photoreceptor or a photoconductor) and an image forming method, an image forming apparatus, and a process cartridge using the image bearing member.

2. Description of the Background Art

Recently, organic photoconductors (OPCs) have been used in place of inorganic photoreceptors for photocopiers, facsimile machines, laser printers, and multi-functional devices thereof in light of the performance advantages that OPCs offer.

Specific reasons for such supersession include, for example, (1) good optical characteristics, for example, a wider range of optical absorption wavelengths and a greater amount of light absorption; (2) good electrical characteristics, for example, high sensitivity and stable chargeability; (3) a wider selection of materials; (4) ease of manufacture; (5) inexpensive cost; and (6) lack of toxicity.

In addition, as is know, the trend toward smaller image forming apparatuses has also accelerated the size reduction of image bearing members. Therefore, with advances in high-speed performance and maintenance-free design, an image bearing member having high durability is sought. From this point of view, the organic photoconductor has a disadvantage in that it is soft in general and easily worn down because the surface layer thereof is mainly made of a low molecular weight charge transport material and an inert polymer. Thus, the organic photoconductor tends to be abraded under mechanical stress by a developing system or a cleaning system provided around the photoconductor over repetitive use in the electrophotography process.

In addition, size-reduced toner particles have been developed to satisfy the demand for improved image quality, and these smaller toner particles in turn requires improved cleaning performance. Therefore, for example, a cleaning blade formed of harder rubber is pressed against an organic photoconductor with increased pressure. However, this action accelerates abrasion of the organic photoconductor. Such abrasion of a photoreceptor leads to deterioration of the electrical characteristics of the photoreceptor described above, such as the sensitivity and the chargeability, resulting in production of defective images having, for example, low image density and background fouling. Furthermore, when a photoreceptor is locally damaged, defective images having streaks are produced due to poor cleaning performance.

Various approaches to improving the durability of the organic photoconductor have been tried. For example, Japanese patent application publication no. S56-48637 (JP-S56-48637-A) describes a charge transport layer using a curable binder resin and JP-S64-1728-A describes a charge transport layer using a charge transport polymer. However, in the former, since the charge transport layer contains a charge transport material having a low molecular weight, the charge transport layer does not have sufficient durability. In the latter, just because the charge transport polymer is contained in the charge transport layer does not secure sufficient durability.

In addition, JP-H04-281461-A describes a charge transport layer having an inorganic filler to improve durability against abrasion using functional separation. However, a problem with this technology is that the inorganic filler and a dispersion agent to disperse the inorganic filler have an adverse impact on electrostatic chargeability.

Furthermore, among the curable binder resins similar to those described in JP-S56-48637-A, Japanese patent no. 3262488 (JP-3262488-B) describes an acrylate cured monomer having multiple functional groups to improve the cross-linking density, JP-3194392-B describes a charge transport layer formed by using a liquid application containing a monomer having a carbon-carbon double bond, a charge transport material having a carbon-carbon double bond, and a binder resin, and JP-2000-66425-A describes a charge transport layer having a compound formed by curing a positive hole transport compound having two or more chain-reactionary polymerizable functional groups in one molecular. Although these approaches are generally successful in improving durability, further improvement is desired.

In addition to enhancing the durability of the image bearing member, to reduce the amount of a material attaching to the surface of the image bearing member, JP-H06-118681-A describes using a curable silicone resin containing colloidal silica, JP-H09-124943-A and JP-H09-190004-A describe providing a resin layer in which an organic silicon modified positive hole transport compound is bonded with a curable organic silicon-based polymer, and JP-2000-171990-A describes a compound having a three-dimensional network structure formed by curing a curable siloxane resin having a charge transport property imparting group.

These approaches are highly successful at preventing attachment of foreign objects to the photoconductor. However, a charge transport material and a siloxane component are not very compatible in most cases. Therefore, a charge transport material having a hydroxyl group is used to improve compatibility in curing the combination of the charge transport material and an alkoxysilane. However, the number of remaining hydroxyl groups tends to increase in such a case so that blurred images tend to be produced in a high-moisture environment, necessitating the use of a drum heater, etc. In addition, the obtained durability is not sufficient, either.

Moreover, as cross-linking resin structures other than the structures described above, JP-2003-186223-A describes a structure containing a charge transport material having at least one hydroxyl group, a three-dimensionally cross-linked resin, and electroconductive particulates, JP-2007-293197-A describes a structure having a cross-linked resin formed by the cross-linking bonding between a polyol having at least two hydroxyl groups and a reactive charge transport material and an aromatic isocyanate compound, JP-2008-299327-A describes a structure containing a charge transport material having at least one hydroxyl group and a three-dimensionally cross-linked melamine formaldehyde resin, and JP-4262061-B describes a structure having a charge transport material having a hydroxyl group and a three-dimensionally cross-linked resol type phenolic resin.

However, these arrangements are not free from the problem of residual hydroxyl groups. In particular, when a charge transport material having a hydroxyl group is added to a phenolic resin followed by curing, the phenolic hydroxyl group tends to have an adverse impact on the electrical characteristics, which should be avoided by controlling the amount of the phenolic resin and substituting the phenolic hydroxyl group with a particular group.

Furthermore, by substituting the phenolic hydroxyl group with a particular resin, the wettability to a hydrophobic resin is improved and the film-forming property of the protection layer in the lamination process can be improved. However, it is not easy to form a uniform phenolic resin layer using a solvent in which the hydrophobic resin constituting a charge transport layer below the protection layer is barely soluble.

### SUMMARY OF THE INVENTION

In view of the foregoing, as one aspect of the present invention provides an improved image bearing member having a substrate and a layer provided overlying the substrate, the latter containing a cured material in which a compound containing three or more methylol groups and a charge transport group is cross-linked.

It is preferred that, in the image bearing member described above, the compound is 4,4′,4″-trimethylo triphenyl amine, represented by the following chemical structure 1.

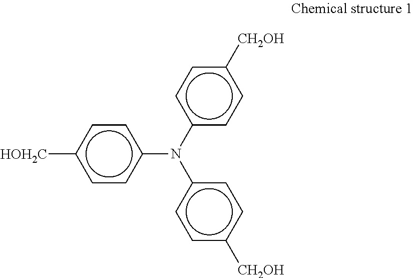

It is still further preferred that, in the image bearing member described above, the compound is represented by the following chemical structure 2;

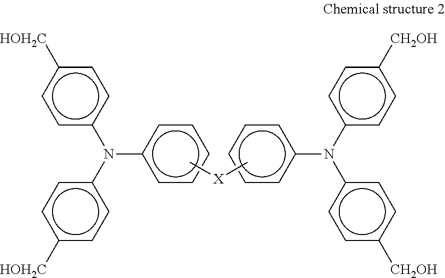

where X represents —O—, —CH₂—, —CH═CH—, and —CH₂CH₂.

It is still further preferred that, in the image bearing member described above, the layer forms an uppermost surface layer of the image bearing member.

It is still further preferred that the image bearing member described above contains a charge generation layer, a charge transport layer, and a cross-linked type charge transport layer formed on the substrate in that sequence and wherein the cross-linked type charge transport layer forms an uppermost surface layer of the image bearing member.

As another aspect of the present invention, an image forming method is provided which includes charging the surface of the image bearing member described above, irradiating the surface of the image bearing member with light to form a latent electrostatic image thereon, developing the latent electrostatic image with a development agent containing toner to obtain a visual image, transferring the visual image to the recording medium, and fixing the visual image on the recording medium.

As yet another aspect of the present invention, an image forming apparatus is provided which includes the image bearing member described above, a charger to charge the surface of the image bearing member, an irradiator to irradiate the surface of the image bearing member with light to form a latent electrostatic image thereon, a development device to develop the latent electrostatic image with a development agent containing toner to obtain a visual image, a transfer device to transfer the visual image to a recording medium, and a fixing device to fix the visual image on the recording medium.

As still yet another aspect of the present invention, a process cartridge is provided which includes the image bearing member described above and at least one device selected from the group consisting of a charger, an irradiator, a development agent, a transfer device, a cleaning device, and a discharging device, wherein the process cartridge is detachably attachable to an image forming apparatus.

### BRIEF DESCRIPTION OF THE DRAWINGS

Various other objects, features, and attendant advantages of the present invention will be more fully appreciated as the same becomes better understood from the detailed description when considered in connection with the accompanying drawings in which like reference characters designate like corresponding parts throughout and wherein:

FIG. 1 is an infrared absorption spectrum (KBr tablet method) of an illustrated compound 1 obtained in the synthesis example 1 described later with an X axis representing a wave number (cm⁻¹) and a Y axis representing a transmission ratio (%);

FIG. 2 is an infrared absorption spectrum (KBr tablet method) of a manufacturing intermediate aldehyde compound material of an illustrated compound 2 obtained in the synthesis example 2 described later with an X axis representing a wave number (cm⁻¹) and a Y axis representing a transmission ratio (%);

FIG. 3 is an infrared absorption spectrum (KBr tablet method) of a manufacturing intermediate aldehyde compound of the illustrated compound 2 obtained in the synthesis example 2 described later with an X axis representing a wave number (cm⁻¹) and a Y axis representing a transmission ratio (%);

FIG. 4 is an infrared absorption spectrum (KBr tablet method) of the illustrated compound 2 obtained in the synthesis example 2 described later with an X axis representing a wave number (cm⁻¹) and a Y axis representing a transmission ratio (%);

FIG. 5 is an infrared absorption spectrum (KBr tablet method) of a manufacturing intermediate aldehyde compound material of an illustrated compound 3 obtained in the synthesis example 3 described later with an X axis representing a wave number (cm⁻¹) and a Y axis representing a transmission ratio (%);

FIG. 6 is an infrared absorption spectrum (KBr tablet method) of a manufacturing intermediate aldehyde compound of the illustrated compound 3 obtained in the synthesis example 3 described later with an X axis representing a wave number (cm⁻¹) and a Y axis representing a transmission ratio (%);

FIG. 7 is an infrared absorption spectrum (KBr tablet method) of the illustrated compound 3 obtained in the synthesis example 3 described later with an X axis representing a wave number (cm⁻¹) and a Y axis representing a transmission ratio (%);

FIG. 8 is an infrared absorption spectrum (KBr tablet method) of a manufacturing intermediate aldehyde compound material of an illustrated compound 4 obtained in the synthesis example 4 described later with an X axis representing a wave number (cm⁻¹) and a Y axis representing a transmission ratio (%);

FIG. 9 is an infrared absorption spectrum (KBr tablet method) of a manufacturing intermediate aldehyde compound of the illustrated compound 4 obtained in the synthesis example 4 described later with an X axis representing a wave number (cm⁻¹) and a Y axis representing a transmission ratio (%);

FIG. 10 is an infrared absorption spectrum (KBr tablet method) of the illustrated compound 4 obtained in the synthesis example 4 described later with an X axis representing a wave number (cm⁻¹) and a Y axis representing a transmission ratio (%);

FIG. 11 is an infrared absorption spectrum (KBr tablet method) of a manufacturing intermediate aldehyde compound material of an illustrated compound 5 obtained in the synthesis example 5 described later with an X axis representing a wave number (cm⁻¹) and a Y axis representing a transmission ratio (%);

FIG. 12 is an infrared absorption spectrum (KBr tablet method) of a manufacturing intermediate aldehyde compound of the illustrated compound 5 obtained in the synthesis example 5 described later with an X axis representing a wave number (cm⁻¹) and a Y axis representing a transmission ratio (%);

FIG. 13 is an infrared absorption spectrum (KBr tablet method) of the illustrated compound 5 obtained in the synthesis example 5 described later with an X axis representing a wave number (cm⁻¹) and a Y axis representing a transmission ratio (%);

FIG. 14 is a schematic diagram illustrating an example of an electrophotographic process and an image forming apparatus of the present disclosure;

FIG. 15 is a diagram illustrating another example of the electrophotographic process of the present disclosure; and

FIG. 16 is a schematic diagram illustrating an example of a process cartridge of the present disclosure.

### DETAILED DESCRIPTION OF THE PRESENT DISCLOSURE

The image bearing member, the image forming method, the image forming apparatus, and the process cartridge of the present disclosure are described in detail below.

The image bearing member of the present disclosure has a layer containing a cured material in which a compound having three or more methylol groups and a charge transport group is cross-linked.

The image bearing member of the present disclosure has no specific limit to its layer structure. Since the layer containing the cured material has an excellent durability and electric property, it is preferable to form the layer as the uppermost surface layer of the image bearing member.

In addition, since the compound represented by the following chemical structures 1 and 2 has a hole transport property, the layer is preferably formed as the surface of an organic photoconductor employing a negative charging system.

A representative example of the organic photoconductor employing the negative charging system includes a substrate on which at least an undercoating layer, a charge generation layer, and a charge transport layer are laminated in that sequence and the charge transport layer contains the cured material described above. However, since the thickness of the charge transport layer is limited by the curing condition, it is most preferable to have a structure in which a cross-linked type charge transport layer is provided on the charge transport layer and contains the cured material described above.

In addition, an image bearing member having a single photosensitive layer assuming the basic functions of charge generation and charge transport of the image bearing member with the uppermost surface layer containing the cured material described above thereon can be also used.

The image bearing member of the present disclosure prevents an external additive having an extremely hardness such as silica particulates in the toner from sticking in the image bearing member, thereby reducing production of defective images having white mottles while maintaining excellent durability and electric characteristics. The mechanism is inferred as follows.

The surface layer of a typical image bearing member has a thermoplastic resin in which a charge transport agent having a low molecular weight is dispersed and is relatively soft in comparison with inorganic fillers such as silica so that the inorganic fillers easily stick in the surface layer. Therefore, it is necessary to increase the surface hardness. The surface hardness is not improved by using a charge transport polymer resin while eliminating the use of the dispersed charge transport agent having a low molecular weight but a cross-linked resin having a high cross-linking density. In particular, a cross-linked layer using a monomer having multiple functional groups is advantageous.

On the other hand, to demonstrate excellent electric characteristics as an image bearing member, a charge transport component is required to be taken in the cross-linked layer.

Although the durability against abrasion is improved by such a cross-linked layer using a monomer having multiple functional groups, the substitution groups related to the cross-linking are polar groups in most cases, thereby degrading the electric characteristics when the charge transport component is added followed by curing. Therefore, it is difficult to satisfy all the characteristics.

In the present disclosure, a compound having three or more methylol groups and a charge transport group having no adverse impact on the electric characteristics is used so that excellent durability and electric characteristics are sustained by curing of the methylol groups having a high reactivity, thereby reducing production of defective images having white mottles. In addition, since the compound is composed of only materials having a low molecular weight, the wettability against a hydrophobic resin is improved and a cross-linked type charge transport layer is easily uniformly formed on the charge transport layer in an image bearing member having a laminate structure.

To promote the cross-linking reaction by heating, curing catalysts such as curing promoter and a polymerization initiator can be added.

A detailed cross-linking mechanism has not been clear yet but the cross-linking reaction of a triphenyl amine compound having a methylol group proceeds under the presence of an extremely minute quantity of a curing catalyst.

It is already known that an ether bond between methylol groups by condensation reaction, a methylene bond while the condensation reaction furthermore proceeds, or a methylene bond by condensation reaction between the methylol group and a hydrogen atom in the benzene ring in a triphenyl amine structure are formed. A three-dimensional cured layer having an extremely high cross-linking density is obtained by those condensation reactions between molecules.

As described above, in the present disclosure, a layer having a high wettability against a hydrophobic resin and an extremely high cross-linking density can be uniformly formed while sustaining excellent electric characteristics, thereby satisfying various kinds of characteristics of the image bearing member, preventing silica particulates, etc. from sticking in the image bearing member, and reducing production of defective images having white mottles.

Therefore, the image bearing member of the present disclosure has such a structure that an image forming method, an image forming apparatus, and a process cartridge using the image bearing member that can produce quality images for an extended period of time can be provided.

### Image Bearing Member

The image bearing member of the present disclosure has a layer containing a cured material in which a compound having three or more methylol groups and a charge transport group is cross-linked.

### Layer Containing Cured Material

The cured material described above is formed by cross-linking a compound having three or more methylol groups and a charge transport group.

As the compound having three or more methylol groups and a charge transport group, compounds represented by the following chemical structures 1 or 2 are preferable.

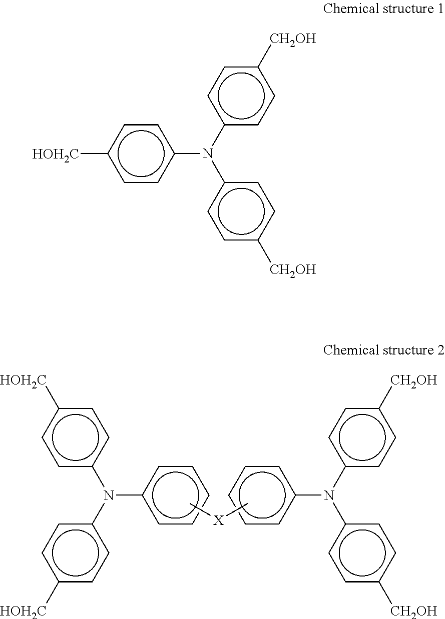

In the chemical structure 2, X represents —O—, —CH₂—, —CH═CH—, and —CH₂CH₂—.

The methylol compound represented by the chemical structure 1 is referred to as Compound No. 1.

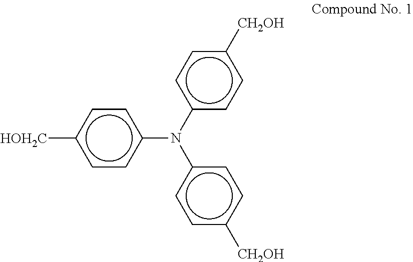

Specific examples of the methylol compound represented by the chemical structure 2 are as follows but are not limited thereto.

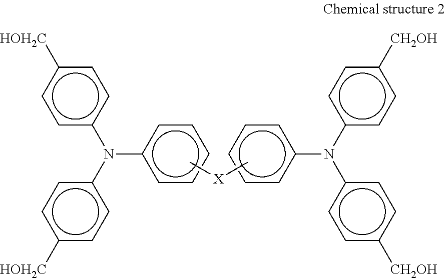

| Compound No. | 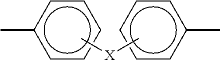 |
|---|---|
| 2 | 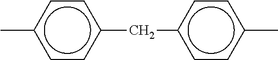 |
| 3 | 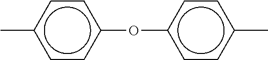 |
| 4 | 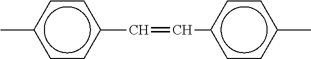 |
| 5 | 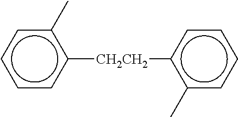 |
| 6 | 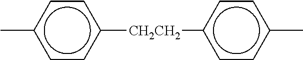 |
| 7 | 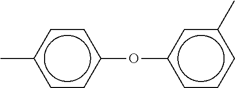 |

For example, the methylol compound represented by the chemical structure 1 or 2 can be easily manufactured by preparing an aldehyde compound by the following procedure to react the thus prepared aldehyde compound and a reducing agent such as hydrogenated boron sodium.

### Synthesis of Aldehyde Compound

An aldehyde compound can be synthesized by formylating a triphenyl amine compound as a raw material by a typical method (such as Vilsmeier reaction). Refer to JP-3943522-B for a specific example of formylation.

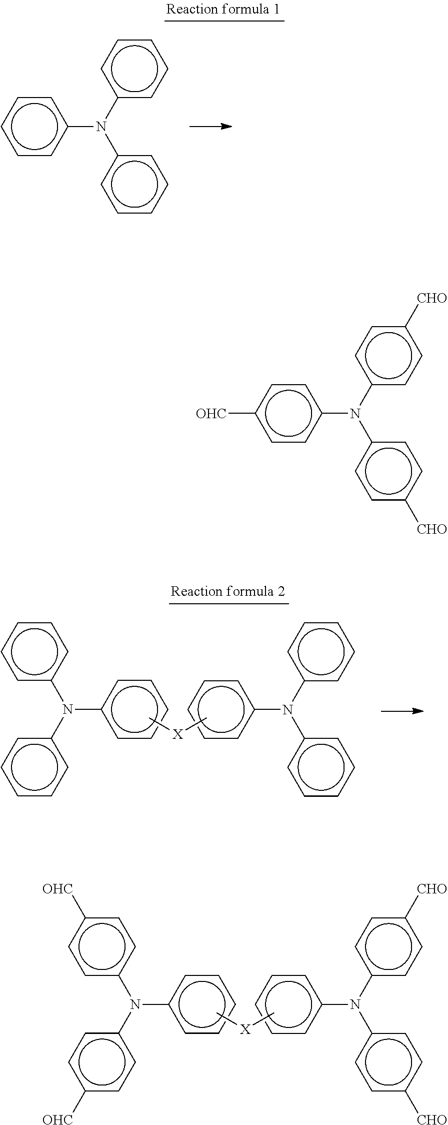

A formylation method of using zinc chloride, oxy chlorinated phosphorous, and dimethyl formaldehyde is effective as the formylation method described above. However, the synthesis method of the aldehyde compound used as an intermediate compound for use in the present disclosure is not limited thereto.

Specific synthesis examples are deferred.

### Synthesis of Methylol Compound

A methylol compound can be synthesized by a typical reductive method using an aldehyde compound used as a manufacturing intermediate as shown in the following reaction formula.

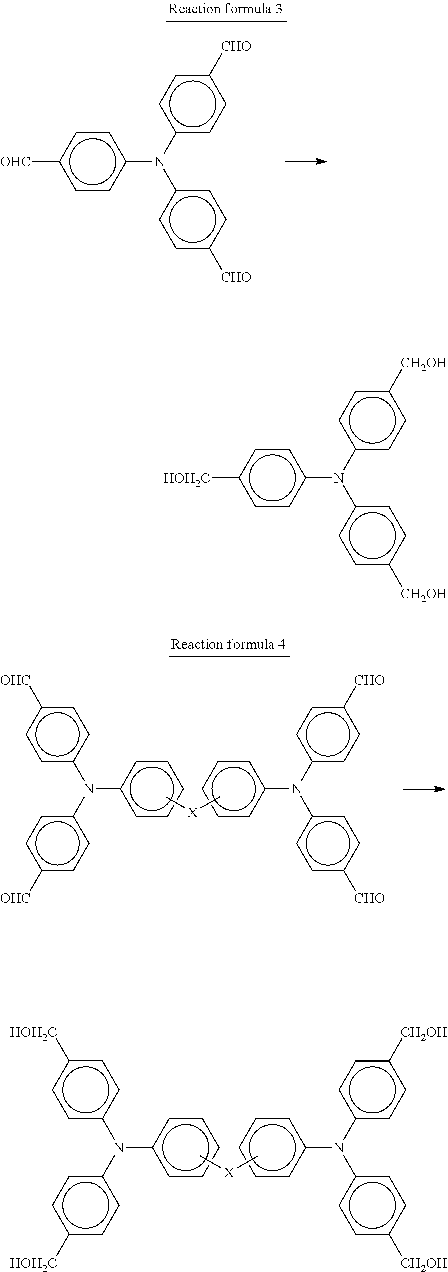

In a specific reductive method, hydrogenated boron sodium is used but the synthesis method of manufacturing the methylol compound of the present disclosure is not limited thereto. Descriptions of specific synthesis examples are deferred.

The methylol compound illustrated above is easily obtained by conducting reductive reaction of the thus synthesized aldehyde compound used as a manufacturing intermediate. Furthermore, other illustrated Compounds Nos. 1 to 7 are easily prepared by the reaction described above.

In the present disclosure, it is possible to form a layer having an excellent charge transport property and an extremely high cross-linking density by curing a compound having highly reactive methylol groups and a charge transport group without having an adverse impact on the electric characteristics. That is, the layer satisfies the demand with regard to the mechanical durability against abrasion and the heat resistance and demonstrates good charge transport properties without degrading such properties. Because of this, using this layer is extremely good for an organic photoconductor.

Next, a method of forming a layer containing the cured material is described.

The layer containing the cured material can be formed as follows: prepare a liquid application that contains a compound having three or more methylol groups and a charge transport group and a catalyst for curing reaction; apply the liquid application to the surface of an image bearing member; and heating the surface followed by drying for polymerization.

Specific examples of the catalyst for polymerization reaction, i.e., curing reaction, include, but are not limited to, acid catalyst such as hydrochloric acid, paratoluene sulfonate, vinyl sulfonate, trifluoro acetate, and oxalic acid. A strong acid is preferable in terms of conducting curing reaction sufficiently. In addition, an organic acid is more preferable as the catalyst in terms of the compatibility with the compound having three or more methylol groups and a charge transport group contained in the liquid application.

The content of the catalyst is preferably from 0.1 to 2.0% by weight as the weight ratio thereof to the compound having three or more methylol groups and a charge transport group. When the weight ratio is too small, the curing reaction may not proceed sufficiently. To the contrary, when the weight ratio is too large, the catalyst tends to have an adverse impact on the electrostatic characteristics of an image bearing member.

When a liquid polymerizable monomer is used for the liquid application, other components are possibly dissolved in the liquid but optionally in a solvent before coating.

Specific examples of such a solvent include, but are not limited to, alcohols such as methanol, ethanol, propanol and butanol; ketones such as acetone, methyl ethyl ketone, methyl isobutyl ketone, and cycle hexanone; esters such as ethyl acetate and butyl acetate; ethers such as tetrahydrofuranm dioxane, and propyl ether; halogen based solvents such as dichloromethane, dichloroethane, trichloroethane, and chlorobenzene; aromatic series based solvents such as benzene, toluene, and xylene; and cellosolve based solvents such as methyl cellosolve, ethyl cellosove, and cellosolve acetate. These solvents can be used alone or in combination.

The dilution ratio by using such a solvent is arbitrary and varies depending on the solubility of a composition, a coating method, and a target layer thickness. A dip coating method, a spray coating method, a bead coating method, a ring coating method, etc., can be used in application of the liquid application.

Furthermore, the liquid application optionally includes additives such as plasticizers (for relaxing internal stress or improving adhesiveness), a leveling agent, a charge transport material having a low molecular weight having no reaction property. Any known additives can be suitably used. Silicone oils such as dimethyl silicone oil and methyl phenyl silicone oil and a polymer or an oligomer having a perfluoroalkyl group in its side chain can be used as the leveling agent. The content thereof is suitably not greater than 3% by weight based on the total solid portion of the liquid application.

After the liquid application is applied, the applied layer is heated and dried for curing. The heating temperature is preferably from 130° C. to 150° C. When the heating temperature is too low, the curing reaction may not proceed sufficiently. To the contrary, a heating temperature that is too high tends to cause local curing due to rapid curing reaction so that the formed layer is brittle. Although the drying time slightly changes depending on the temperature, thirty minutes or longer is preferable when the heating temperature is 130° C.

When the drying time is too short, the curing reaction may not proceed sufficiently. As the drying time increases, the curing reaction proceeds more. However, in light of shortening the manufacturing time, a short drying time is preferable. In light of the present disclosure, a layer having an extremely high cross-linking density is suitable. When the gel fraction is used as an indicator of the cross-linking density, the gel fraction is preferably 95% or higher and more preferably 97% or higher. By increasing the gel fraction, it is possible to prevent silica, etc. from sticking in the surface of an image bearing member in addition to improvement of the durability against abrasion thereof. The gel fraction is obtained by dipping the cured material in an organic solvent such as tetrahydrofuran having a high solubility for five days, measuring the amount of decreased weight of the cured material, and assigning the measuring result in the following relationship 1.

Gel fraction (%)=100×(weight of cured material after dipping and drying/original weight of cured material) Relationship 1

The thickness of a layer containing the cured material is preferably 3 μm or more in particular for a layer structure of an image bearing member in which a cross-linked type charge transport layer containing the cured material is provided on a charge transport layer.

When the thickness is too thin, the component of the charge transport layer beneath the cross-linked type charge transport layer easily mingles into the cross-linked type charge transport layer when the liquid application thereof is applied to the charge transport layer and the mingled component tends to diffuse into the entire of the cross-linked type charge transport layer, thereby inhibiting the curing reaction and decreasing the cross-linking density.

In addition, if the thickness decreases due to abrasion over repetitive use, the chargeability and the sensitivity tend to locally change. Therefore, the thickness of the cross-linked type charge transport layer is preferably 3 μm or more in terms of extension of the working life of an image bearing member.

In addition, in the case of a layer structure of an image bearing member in which the cross-linked type charge transport layer containing the cured material is provided on a charge generation layer with no charge transport layer therebetween, the charge transport layer containing the cured material preferably has a thickness of 10 μm or more in terms of the charging voltage of the image bearing member.

With regard to the upper limit of the thickness, although it is possible to determine a suitable thickness considering the layer structure, the thickness between the upper portion of the charge generation layer to the surface is preferably 40 μm or less.

Moreover, in the case of the layer structure having the uppermost layer containing the cured material on a single-layered photosensitive layer, the thickness is preferably 3 μm or more as in the case of the cross-linked charge transport layer described above.

The image bearing member preferably has a structure in which at least a charge generation layer, a charge transport layer, and the cross-linked type charge transport layer are provided on a substrate with optional layers such as an intermediate layer. The cross-linked type charge transport layer contains the cured material of the present disclosure.

### Charge Generation Layer

The charge generation layer contains at least a charge generation material and other optional materials such as a binder resin. Inorganic materials and organic materials can be used as the charge generating material.

Specific examples of the inorganic materials include, but are not limited to, crystal selenium, amorphous-selenium, selenium-tellurium-halogen, selenium-arsenic compounds, and amorphous-silicon. With regard to the amorphous-silicon, those in which a dangling-bond is terminated with a hydrogen atom or a halogen atom, and those in which boron atoms or phosphorous atoms are doped are preferably used.

There is no specific limit to the selection of the organic materials and any known material can be suitably used. Specific examples thereof include, but are not limited to, phthalocyanine pigments, for example, metal phthalocyanine and metal-free phthalocyanine; azulenium salt pigments; squaric acid methine pigments; azo pigments having a carbazole skeleton; azo pigments having a triphenylamine skeleton; azo pigments having a diphenylamine skeleton; azo pigments having a dibenzothiophene skeleton; azo pigments having a fluorenone skeleton; azo pigments having an oxadiazole skeleton; azo pigments having a bis-stilbene skeleton; azo pigments having a distilyloxadiazole skeleton; azo pigments having a distylylcarbazole skeleton; perylene pigments, anthraquinone or polycyclic quinone pigments; quinoneimine pigments; diphenylmethane and triphenylmethane pigments; benzoquinone and naphthoquinone pigments; cyanine and azomethine pigments, indigoid pigments, and bis-benzimidazole pigments. These can be used alone or in combination.

There is no specific limit to the selection of the binder resin for use in the charge generation layer. Specific examples of the binder resin include, but are not limited to, polyamide resins, polyurethane resins, epoxy resins, polyketone resins, polycarbonate resins, silicone resins, acrylic resins, polyvinylbutyral resins, polyvinylformal resins, polyvinylketone resins, polystyrene resins, poly-N-vinylcarbazole resins, and polyacrylamide resins. These can be used alone or in combination.

In addition to the binder resins specified above for the charge generation layer, charge transport polymers having a charge transport function, for example, (1) a polycarbonate resin, a polyester resin, a polyurethane resin, a polyether resin, a polysiloxane resin, or an acrylic resin having an arylamine skeleton, a benzidine skeleton, a hydrazone skeleton, a carbazole skeleton, a stilbene skeleton, or a pyrazoline skeleton; and (2) a polymerizable material having a polysilane skeleton, can be also used.

Specific examples of (1) the charge transport polymers include, but are not limited to, charge transport polymer materials described in JP-H01-001728-A, JP-H01-009964-A, JP-H01-013061-A, JP-H01-019049-A, JP-H01-241559-A, JP-H04-011627-A, JP-H04-175337-A, JP-H04-183719-A, JP-H04-225014-A, JP-H04-230767-A, JP-H04-320420-A, JP-H05-232727-A, JP-H05-310904-A, JP-H06-234836-A, JP-H06-234837-A, JP-H06-234838-A, JP-H06-234839-A, JP-H06-234840-A, JP-H06-234840-A, JP-H06-234841-A, JP-H06-239049-A, JP-H06-236050-A, JP-H06-236051-A, JP-H06-295077-A, JP-H07-056374-A, JP-H08-176293-A, JP-H08-208820-A, JP-H08-211640-A, JP-H08-253568-A, JP-H08-269183-A, JP-H09-062019-A, JP-H09043883-A, JP-H09-71642-A, JP-H09-87376-A, JP-H09-104746-A, JP-H09-110974-A, JP-H09-110974-A, JP-H09-110976-A, JP-H09-157378-A, JP-H09-221544-A, JP-H09-227669-A, JP-H09-221544-A, JP-H09-227669-A, JP-H09-235367-A, JP-H09-241369-A, JP-H09-268226-A, JP-H09-272735-A, JP-H09-272735-A, JP-H09-302084-A, JP-H09-302085-A, and JP-H09-328539-A.

Specific examples of (2) polymerizable materials having a polysilane skeleton include, but are not limited to, polysiylene polymers described in JP-S63-285552-A, JP-H05-19497-A, JP-H05-70595-A, and JP-H10-73944-A.

The charge generation layer optionally contains a charge transport material having a low molecular weight. The charge transport material having a low molecular weight is typified into a positive hole transport material and an electron transport material.

Specific examples of such electron transport materials include, but are not limited to, chloranil, bromanil, tetracyano ethylene, tetracyanoquino dimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, and diphenoquinone derivatives. These can be used alone or in combination.

Specific examples of such positive hole transport material include, but are not limited to, oxazole derivatives, oxadiazole derivatives, imidazole derivatives, monoaryl amine derivatives, diaryl amine derivatives, triaryl amine derivatives, stilbene derivatives, α-phenyl stilbene derivatives, benzidine derivatives, diaryl methane derivatives, triaryl methane derivatives, 9-styryl anthracene derivatives, pyrazoline derivatives, divinyl benzene derivatives, hydrazone derivatives, indene derivatives, butadiene derivatives, pyrene derivatives, bisstilbene derivatives, enamine derivatives, and other known materials. These can be used alone or in combination.

The charge generation layer is typically manufactured by a vacuum thin layer forming method or a casting method using a liquid dispersion system.

Specific examples of the vacuum thin layer forming methods include, but are not limited to, a vacuum evaporation method, a glow discharge decomposition method, an ion-plating method, a sputtering method, a reactive sputtering method, and a CVD method.

In the casting method, the above-mentioned inorganic or organic charge generation material is dispersed with an optional binder resin in a solvent, for example, tetrahydrofuran, dioxane, dioxsolan, toluene, dichloromethane, monochlorobenzene, dichloroethane, cyclohexanone, cyclopentanone, anisole, xylene, methylethylketone, acetone, ethylacetate, butylacetate using, for example, a ball mill, an attritor, a sand mill, or a bead mill. After the thus obtained liquid dispersion is suitably diluted, the liquid dispersion is applied to the surface of the electroconductive substrate to form the charge generation layer. Leveling agents such as dimethyl silicone oil, and methylphenyl silicone oil, can be optionally added. A dip coating method, a spray coating method, a bead coating method, a ring coating method, etc., can be used for application of the liquid application.

There is no specific limit to the thickness of the charge generation layer. The charge generation layer preferably has a thickness of from 0.01 to 5 μm and more preferably from 0.05 to 2 μm.

### Charge Transport Layer

When the layer containing the cured material is the cross-linked type charge transport layer provided on the charge transport layer, the charge transport layer holds charges and bonds the held charges with charges generated and separated in the charge generation layer by irradiation and transferring. In addition, to hold the charge, the electric resistance is required to be high. Furthermore, to obtain a high surface voltage by the held charges, the layer is required to have a small dielectric constant and a good charge mobility.

The charge transport layer contains at least a charge transport material, binder resin, and other optional materials.

The charge transport material is classified into positive hole transport materials, electron transport materials, and charge transport polymers.

Specific examples of such electron transport materials (electron accepting materials) include, but are not limited to, chloranil, bromanil, tetracyano ethylene, tetracyanoquino dimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2,b]thiophene-4-one, and 1,3,7-trinitro dibenzothiophene-5,5-dioxide. These can be used alone or in combination.

Specific examples of the positive hole carrier transport materials (electron donating materials) include, but are not limited to, oxazole derivatives, oxadiazole derivatives, imidazole derivatives, triphenyl amine derivatives, 9-(p-diethylaminostyryl anthracene), 1,1-bis-(4-dibenzyl aminophenyl)propane, styrylanthracene, styrylpyrazoline, phenylhydrazones, α-phenylstilbene derivatives, thiazole derivatives, triazole derivatives, phenazine derivatives, acridine derivatives, benzfuran derivatives, benzimidazole derivatives, and thiophene derivatives. These can be used alone or in combination.

Specific examples of the charge transport polymers include, but are not limited to, compounds having the following structure.

(a) Specific examples of the polymer having a carbazole ring include, but are not limited to, poly-N-vinylcarbazole, and polymers described in JP-S50-82056-A, JP-S54-9632-A, JP-S54-11737-A, JP-H04-175337-A, JP-H04-183719-A, and JP-H06-234841-A.
(b) Specific examples of the polymer having a hydrorazone structure include, but are not limited to, polymers described in JP-S57-78402-A, JP-S61-20953-A, JP-S61-296358-A, JP-H01-134456-A, JP-H01-179164-A, JP-H03-180851-A, JP-H03-180852-A, JP-H03-50555-A, JP-H05-310904-A, and JP-H06-234840-A.
(c) Specific examples of the polysilylnene polymer include, but are not limited to, polymers described in JP-S63-285552-A, JP-H01-88461-A, JP-H04-264130-A, JP-H04-264131-A, JP-H04-264132-A, JP-H04-264133-A, and JP-H04-289867-A.
(d) Specific examples of the polymer having a triarylamine structure include, but are not limited to, N,N,bis(4-methylphenyl)-4-aminopolystyrene, polymers described in JP-H01-134457-A, JP-H02-282264-A, JP-H02-304456-A, JP-H04-133065-A, JP-H04-133066-A, JP-H05-40350-A, and JP-H05-202135-A.
(e) Specific examples of other polymers include, but are not limited to, condensation polymerized formaldehyde compounds of nitropropylene, and polymers described in JP-S51-73888-A, JP-S56-150749-A, JP-H06-234836-A, and JP-H06-234837-A.

In addition to the compounds specified above, there are other examples of the charge transport polymers and specific examples thereof include, but are not limited to, polycarbonate resins having a triaryl amine structure, polyurethane resins having a triaryl amine structure, polyester resins having a triaryl amine structure, and polyether resins having a triaryl amine structure.

Specific examples of the charge transport polymers include, but are not limited to, polymers specified in JP-S64-1728-A, JP-S64-13061-A, JP-S64-19049-A, JP-H04-11627-A, JP-H04-225014-A, JP-H04-230767-A, JP-H04-320420-A, JP-H05-232727-A, JP-H07-56374-A, JP-H09-127713-A, JP-H09-222740-A, JP-H09-265197-A, JP-H09-211877-A, and H09-304956-A.

Other than the polymers specified above, copolymers, block polymers, graft polymers, and star polymers with a known monomer, and cross-linked polymers having an electron donating group described in JP-H03-109406-A can be used as the polymers having an electron donating group.

Specific examples of the binder resins for use in the charge transport layer include, but are not limited to, polycarbonate resins, polyester resins, methacrylic resins, acrylic resins, polyethylene resins, polyvinyl chloride resins, polyvinyl acetate resins, polystyrene resins, phenolic resins, epoxy resins, polyurethane resins, polyvinylidene chloride resins, alkyd resins, silicone resins, polyvinylcarbazole resins, polyvinyl butyral resins, polyvinyl formal resins, polyacrylate resins, polyacrylic amide resins, and phenoxy resins. These can be used alone or in combination.

The charge transport layer may also contain a copolymer of a cross-linking binder resin and a cross-linking charge transport material.

The charge transport layer can be formed by dissolving or dispersing these charge transport materials and binder resins in a suitable solvent followed by coating and drying. In addition to the charge transport material and binder resin, the charge transport layer can optionally contain additives such as a plasticizing agent, an anti-oxidizing agent, and a leveling agent in a suitable amount, if desired.

The same solvent as specified for the charge generation layer can be used for the charge transport layer. Among those, a solvent is preferable which suitably dissolves the charge transport material and the binder resin. These solvents can be used alone or in combination. In addition, the same method as in the case of the charge generation layer can be used to form the charge transport layer. Furthermore, a plasticizing agent and/or a leveling agent can be added, if desired.

Known plasticizers, for example, dibutyl phthalate and dioctyl phthalate, can be used as the plasticizers. Its content is suitably from 0 to about 30% by weight based on 100 parts by weight of the binder resin.

Specific examples of the leveling agents include, but are not limited to, silicon oils such as dimethyl silicone oil and methylphenyl siliconeoil and polymers or oligomers having a perfluoroalkyl group in its side chain and its suitable content is from 0 to about 1 part by weight based on 100 parts by weight of the binder resin.

There is no specific limit to the layer thickness of the charge transport layer. The thickness thereof can be determined depending on the purpose and preferably ranges from 5 μm to 40 μm and more preferably ranges from 10 μm to 30 μm.

The image bearing member of the present disclosure may have a structure in which at least a single-layered photosensitive layer and a surface layer are provided on a substrate with optional layers such as an intermediate layer. The surface layer contains the cured material of the present disclosure.

### Single Layered Photosensitive Layer

A single-layered photosensitive layer simultaneously has a charge generation function and a charge transport function. The photosensitive layer is formed by dissolving and/or dispersing a charge generation material having a charge generation function, a charge transport material having a charge transport function, and a binder resin in a suitable solvent to obtain a liquid application followed by application and drying thereof.

In addition, a plasticizing agent and/or a leveling agent can be added, if desired. With regard to the dispersion method of the charge generation material, the charge generation material, the charge transport material, the plasticizer, and the leveling agent, the same can be used as in the charge generation layer and the charge transport layer.

In addition to the binder resin specified for the charge transport layer, the binder resin specified for the charge generation layer can be mixed therewith for use. The content of the charge generation material contained in the single-layered photosensitive layer is preferably from 1% to 30% by weight based on the total weight of the photosensitive layer, the binder resin, from 20% to 80% by weight, and the charge transport material, from 10% to 70% by weight. The thickness of such a photosensitive layer is suitably from about 5 μm to about 30 μm and preferably from about 10 μm to about 25 μm.

### Substrate

There is no specific limit to the selection of material for use in the (electroconductive) substrate as long as the material is electroconductive and has a volume resistance of not greater than 1.0×10¹⁰ Ω·cm. For example, there can be used plastic or paper having a film form or cylindrical form covered with a metal such as aluminum, nickel, chrome, nichrome, copper, gold, silver, and platinum, or a metal oxide such as tin oxide and indium oxide by depositing or sputtering. Also a board formed of aluminum, an aluminum alloy, nickel, and a stainless metal can be used. Further, a tube which is manufactured from the board described above by a crafting technique such as extruding and extracting followed by surface-treatment such as cutting, super finishing and grinding is also usable. In addition, an endless nickel belt and an endless stainless belt described in JP-S52-36016-A can be used as the electroconductive substrate.

An electroconductive substrate formed by applying to the substrate described above a liquid application in which electroconductive powder is dispersed in a suitable binder resin can be used as the electroconductive substrate for use in the present disclosure.

Specific examples of such electroconductive powders include, but are not limited to, carbon black, acetylene black, metal powder, such as powder of aluminum, nickel, iron, nichrome, copper, zinc and silver, and metal oxide powder, such as electroconductive tin oxide powder and ITO powder.

Specific examples of the binder resins which are used together with the electroconductive powder include, but are not limited to, thermoplastic resins, thermosetting resins, and optical curing resins, such as a polystyrene, a styrene-acrylonitrile copolymer, a styrene-butadiene copolymer, a styrene-anhydride maleic acid copolymer, a polyester, a polyvinyl chloride, a vinyl chloride-vinyl acetate copolymer, a polyvinyl acetate, a polyvinylidene chloride, a polyarylate (PAR) resin, a phenoxy resin, polycarbonate, a cellulose acetate resin, an ethyl cellulose resin, a polyvinyl butyral, a polyvinyl formal, a polyvinyl toluene, a poly-N-vinyl carbazole, an acrylic resin, a silicone resin, an epoxy resin, a melamine resin, an urethane resin, a phenolic resin, and an alkyd resin.

Such an electroconductive layer can be formed by dispersing the electroconductive powder and the binder resins described above in a suitable solvent, for example, tetrahydrofuran (THF), dichloromethane (MDC), methyl ethyl ketone (MEK), and toluene and applying the resultant to the electroconductive substrate.

In addition, an electroconductive substrate formed by providing a heat contraction tube as an electroconductive layer to a suitable cylindrical substrate can be used as the electroconductive substrate in the present disclosure. The heat contraction tube is formed of a material such as polyvinyl chloride, polypropylene, polyester, polystyrene, polyvinylidene chloride, polyethylene, chloride rubber, and TEFLON®, which contains the electroconductive powder described above.

### Intermediate Layer

In the image bearing member of the present disclosure, an intermediate layer can be provided between the charge transport layer and the cross-linked type charge transport layer to prevent the component of the charge transport layer from mingling into the cross-linked type charge transport layer or to improve the adhesive property between both layers.

Therefore, an intermediate layer is preferable which is hardly soluble or insoluble in a liquid application of the cross-linked type charge transport layer. Generally, a binder resin is used as the main component.

Specific examples of the binder resins include, but are not limited to, polyamide, alcohol soluble nylon, water soluble polyvinylbutyral, polyvinyl butyral, and polyvinyl alcohol. The application methods described above are employed to form the intermediate layer. There is no specific limit to the thickness of the intermediate layer. An intermediate layer having a thickness of from 0.05 μm to 2 μm is suitable.

### Undercoating Layer

In the image bearing member of the present disclosure, an undercoating layer can be provided between the electroconductive substrate and the photosensitive layer.

Typically, such an undercoating layer is mainly made of a resin. Considering that the liquid application of a photosensitive layer is applied to such an undercoating layer (i.e., resin), the resin is preferably hardly soluble in a known organic solvent.

Specific examples of such resins include, but are not limited to, water soluble resins, such as polyvinyl alcohol, casein, and sodium polyacrylate, alcohol soluble resins, such as copolymerized nylon and methoxymethylated nylon, and curing resins which form a three dimensional network structure, such as polyurethane, melamine resins, phenolic resins, alkyd-melamine resins, and epoxy resins. In addition, fine powder pigments of a metal oxide such as titanium oxides, silica, alumina, zirconium oxides, tin oxides, and indium oxides can be added to the undercoating layer to prevent moiré and reduce the residual voltage.

Furthermore, the undercoating layer can be formed by using a material formed by anodizing Al₂O₃ or an organic compound, such as polyparaxylylene (parylene) or an inorganic compound, such as SiO₂, SnO₂, TiO₂, ITO, and CeO₂ manufactured by a vacuum thin-film forming method. Any other known material is also usable.

The undercoating layer described above can be formed by using a suitable solvent and a suitable coating method as described for the photosensitive layer. Furthermore, silane coupling agents, titanium coupling agents, and chromium coupling agents can be used in the undercoating layer. There is no specific limit to the layer thickness of such an undercoating layer. The layer thickness thereof can be determined depending on the purpose and preferably ranges from 0 μm to 5 μm.

Furthermore, in the image bearing member of the present disclosure, an anti-oxidizing agent can be added to each layer, i.e., the cross-linked type charge transport layer, the single-layered photosensitive layer, the charge generation layer, the charge transport layer, the undercoating layer, and the intermediate layer to improve the environmental resistance, in particular, to prevent the degradation of sensitivity and the rise in residual potential.

Specific examples of the anti-oxidants include, but are not limited to, phenol-based compounds, paraphenylene diamines, organic sulfur compounds, and organic phosphorus compounds. These can be used alone or in combination.

Specific examples of the phenol-based compounds include, but are not limited to, 2,6-di-t-butyl-p-cresol, butylated hydroxyanisol, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benz ene, tetrakis-[methylene-3-(3′,5′-di-t-butyl-4′-hydroxyphenyl) propionate]methane, bis[3,3′-bis(4′-hydroxy-3′-t-butylphenyl)butyric acid]glycol ester, and tocopherols.

Specific examples of paraphenylene diamines include, but are not limited to, N-phenyl-N′-isopropyl-p-phenylene diamine, N,N′-di-sec-butyl-p-phenylene diamine, N-phenyl-N-sec-butyl-p-phenylene diamine, N,N′-di-isopropyl-p-phenylene diamine, and N,N′-dimethyl-N,N′-di-t-butyl-p-phenylene diamine.

Specific examples of hydroquinones include, but are not limited to, 2,5-di-t-octyl hydroquinone, 2,6-didodecyl hydroquinone, 2-dodecyl hydroquinone, 2-dodecyl-5-chloro hydroquinone, 2-t-octyl-5-methyl hydroquinone, and 2-(2-octadecenyl)-5-methyl hydroquinone.

Specific examples of the organic sulfur compounds include, but are not limited to, dilauryl-3,3-thiodipropionate, distearyl-3,3′-thiodipropionate, and ditetradecyl-3,3′-thiodipropionate.

Specific examples of the organic phosphorous compounds include, but are not limited to, triphenyl phosphine, tri(nonylphenyl)phosphine, tri(dinonylphenyl)phosphine, tricresyl phosphine, and tri(2,4-dibutylphenoxy)phosphine.

These compounds are known as anti-oxidants for rubber, plastic, and oils and marketed products thereof are available with ease.

There is no specific limit to the addition amount of the anti-oxidant. The addition amount is preferably from 0.01% to 10% by weight based on the total weight of the layer to which the anti-oxidant is added.

The image forming method and the image forming apparatus of the present disclosure are described next with reference to the accompanying drawings.

FIG. 14 is a schematic diagram illustrating the elecrophotography process and the image forming apparatus and the following examples are within the scope of the present disclosure.

The image bearing member 1 has a photosensitive layer. Although the image bearing member 1 has a drum form, it may employ a sheet form or an endless belt form. A sorotron, a scorotron, a solid state charger, a charging roller, and any other known chargers can be used as a charger 3, a pre-transfer charger 7, a transfer charger 10, a separation charger 11, and a pre-cleaning charger 13.

Generally, the chargers described above can be used as the transfer device. A combinational use of the transfer charger and the separation charger as illustrated in FIG. 14 is preferable.

Typical illumination devices, for example, a fluorescent lamp, a tungsten lamp, a halogen lamp, a mercury lamp, a sodium lamp, a light emitting diode (LED), a semiconductor laser (LD), and electroluminescence (EL) can be used as the light source of the irradiator 5 and a discharging lamp 2. Various kinds of optical filters, for example, a sharp cut filter, a band-pass filter, a near infrared filter, a dichroic filter, a coherent filter and a color conversion filter, can be used to irradiate an image bearing member with light having only a particular wavelength.

The light source is used in other processes such as the transfer process, the discharging process, and the cleaning process in which irradiation is used in combination or a pre-irradiation process in addition to the process illustrated in FIG. 14.

Toner for use in developing a latent electrostatic image formed on the image bearing member 1 by a development unit 6 is transferred to a transfer sheet 9. In this process, not all the toner is transferred but part of the toner remains on the image bearing member 1. A single component development agent or a two component development agent containing the toner can be used.

Such remaining toner is removed from the image bearing member 1 by a fur brush 14 or a blade 15. Cleaning is performed only by a cleaning brush in some cases and a known cleaning brush (e.g., the fur brush 14, a magfur brush) is used.

When the image bearing member 1 is positively (or negatively) charged and irradiated according to image data, a positive (or negative) latent electrostatic image is formed on the image bearing member 1.

When the latent electrostatic image is developed with a negatively (or positively) charged toner (volt-detecting fine particles), a positive image is formed. When the latent electrostatic image is developed using a positively (or negatively) charged toner, a negative image is formed.

Any known method can be used for such a development device and also a discharging device.

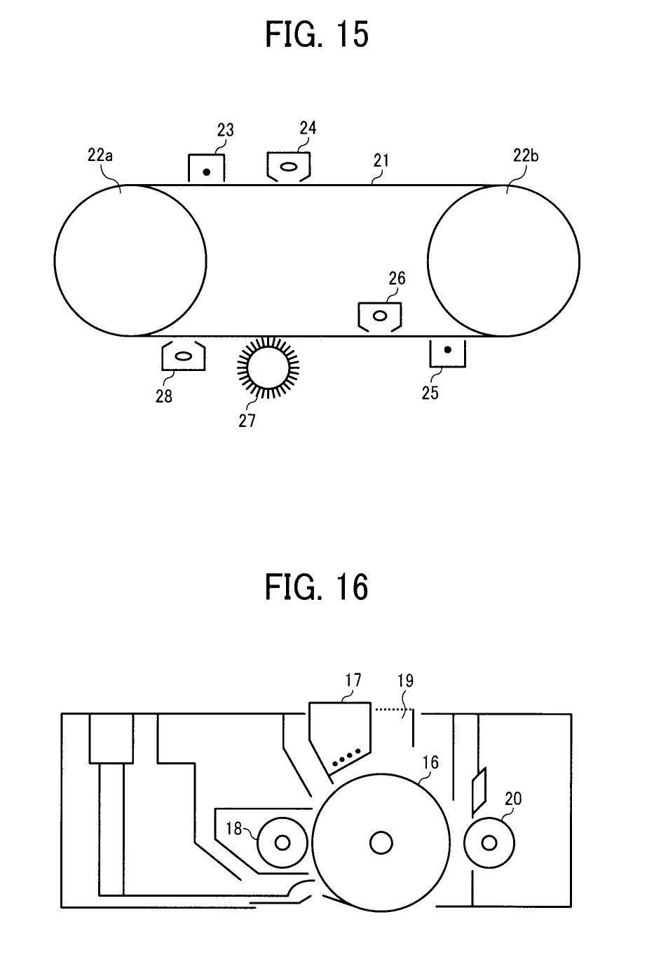

FIG. 15 is a diagram illustrating another example of electrophotography process of the present disclosure.

An image bearing member 21 has at least a photosensitive layer, is driven by driving rollers 22a and 22b, charged by a charger 23, and irradiated by a light source 24 to form a latent electrostatic image thereon. The latent electrostatic images are developed by a development device (not shown) to obtain a visual image. The visual image is transferred by a transfer charger 25. The image bearing member 21 is irradiated by a pre-cleaning irradiator 26 before cleaning, cleaned by a brush 27, and discharged by a discharging light source 28. These processes are repeated when images are formed.

In FIG. 15, the pre-cleaning irradiator 26 irradiates the image bearing member 21 from the substrate side thereof because the image bearing member 21 is transmissive in this example.

The electrophotography processes described above are for the illustration purpose only and the present disclosure is not limited thereto.

For example, in FIG. 15, the pre-cleaning irradiator 26 irradiates the image bearing member 21 from the substrate side thereof. The pre-cleaning irradiator 26 can also irradiates it from the photosensitive layer side. In addition, image irradiation and discharging irradiation can be conducted from the substrate side.

Although the image irradiation, the pre-cleaning irradiation, and the discharging irradiation are illustrated as the light irradiation processes, a pre-transfer irradiation process, a pre-irradiation process of image irradiation, and other known irradiation processes can be provided to irradiate the image bearing member 21.

Although the image formation device as described above can be fixed in a photocopier, a facsimile machine, or a printer, such image formation elements can form a process cartridge that can be incorporated into such an apparatus. The process cartridge is a device (part) including an image bearing member and at least one device selected from other optional devices such as a charger, an irradiator, a development device, a transfer device, a cleaner, and a discharging device. There is no specific limit to the form of the process cartridge but a typical form thereof is as illustrated in FIG. 16. An image bearing member 16 has at least a photosensitive layer on the electroconductive substrate. The reference numerals 17, 18, 19, and 20 represent a charger, a cleaning brush, an irradiator, and a charging roller, respectively.

The image forming apparatus for use in the present disclosure may have a configuration including a process cartridge formed of elements such as the image bearing member described above, a development device, a cleaning device, etc. The process cartridge is detachably attachable to the image forming apparatus.

In addition, a process cartridge can be formed of at least one of the devices of a charging device, an irradiator, a development device, a transfer device, a transfer separator, and a cleaner, unitedly supported with the image bearing member. The process cartridge can be structured as a single unit detachably attachable to the image forming apparatus by a guiding device such as a rail provided therein.

As described above, the image forming method, the image forming apparatus, and the process cartridge of the present disclosure use a laminate type image bearing member having a surface of the cross-linked type charge transport layer having a high durability against abrasion and damage and tough for cracking and peeling-off. In addition, these can be used not only in an electrophotographic photocopier but also in an applied electrophotography field of, for example, a laser beam printer, a CRT printer, an LED printer, a liquid crystal printer, and a laser printing.

Having generally described (preferred embodiments of) this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but not limited thereto.

The present disclosure is described in detail specifying synthesis examples of the compound having three or more methylol groups and a charge transport group.

### Synthesis Example 1

### Synthesis of Illustrated Compound 1

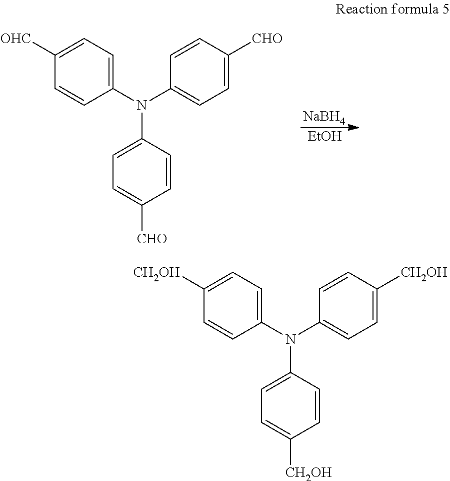

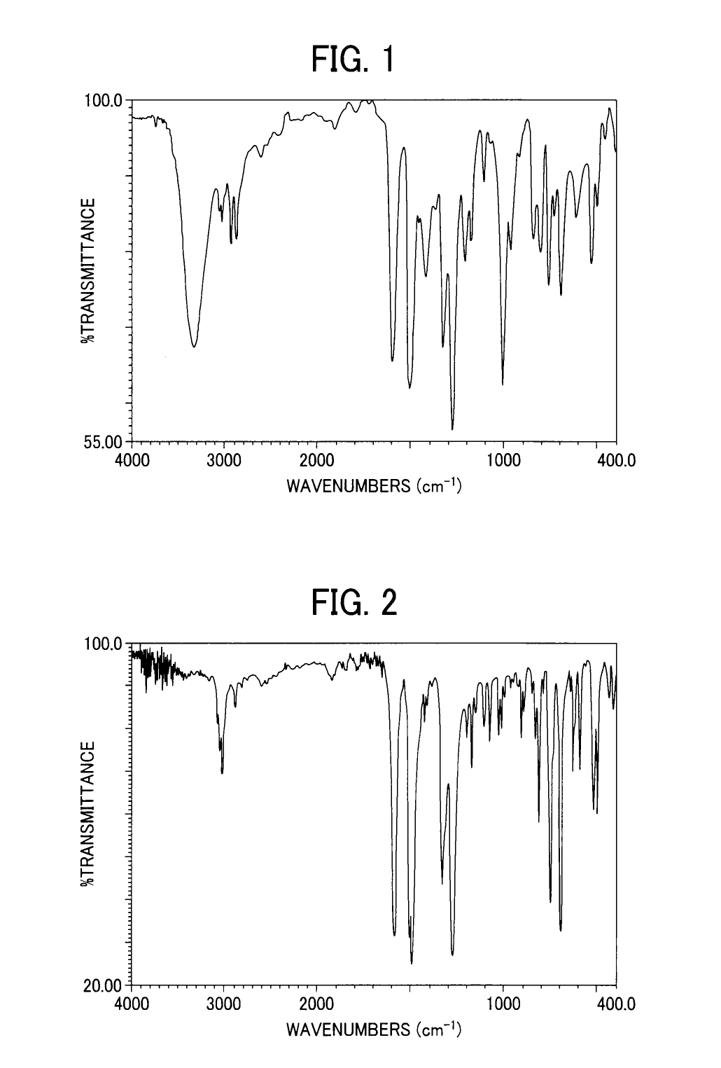

Place 3.29 g of the intermediate aldehyde compound illustrated above in the reaction formula 5 and 50 ml of ethanol in a flask; Stir the mixture at room temperature and drop 1.82 g of hydrogenated boron sodium in the flask; Keep stirring for 12 hours; Extract the resultant with ethyl acetate followed by dehydration with magnesium sulfate and adsorption treatment by activated white earth and silica gel; Filter, wash, and concentrate the resultant to obtain a crystal material; and Disperse the crystal in n-hexane followed by filtration, washing, and drying to obtain the target compound (white crystal, yield: 2.78 g). The infra-red absorption spectrum graph is shown as FIG. 1.

### Synthesis Example 2

### Synthesis of Illustrated Compound 2

Synthesis of Manufacturing Intermediate Aldehyde Compound Material of Illustrated Compound 2

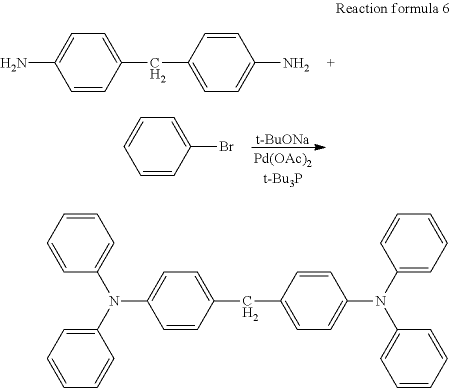

Place 19.83 g of 4,4′-diamino diphenyl methane, 69.08 g of bromobenzene, 2.24 g of paradium acetate, 46.13 g of tertial buthoxy sodium, and 250 ml of o-xylene in a flask; Stir the mixture in argon gas atmosphere at room temperature; Drop 8.09 g of tri-tertial butyl phosphine to the flask; Keep stirring at 80° C. for one hour and reflux the mixture for another one hour while stirring. Dilute the resultant with toluene and place magnesium sulfate, activated white earth, and silica gel in the flask followed by stirring; Filter, wash, and concentrate the resultant to obtain a crystal material; and Disperse the crystal in methanol followed by filtration, washing, and drying to obtain the target compound (intermediate material) (pale yellow powder, yield: 45.73 g).

The infra-red absorption spectrum graph is shown as FIG. 2. Synthesis of Manufacturing Intermediate Aldehyde Compound of Illustrated Compound 2

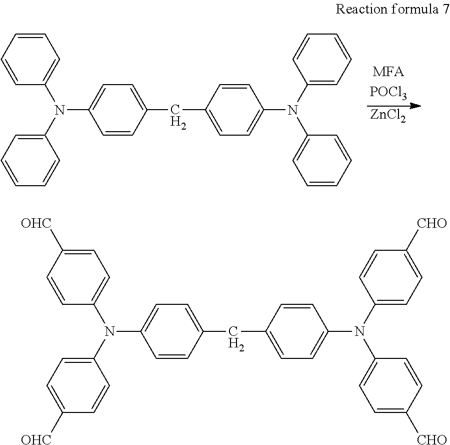

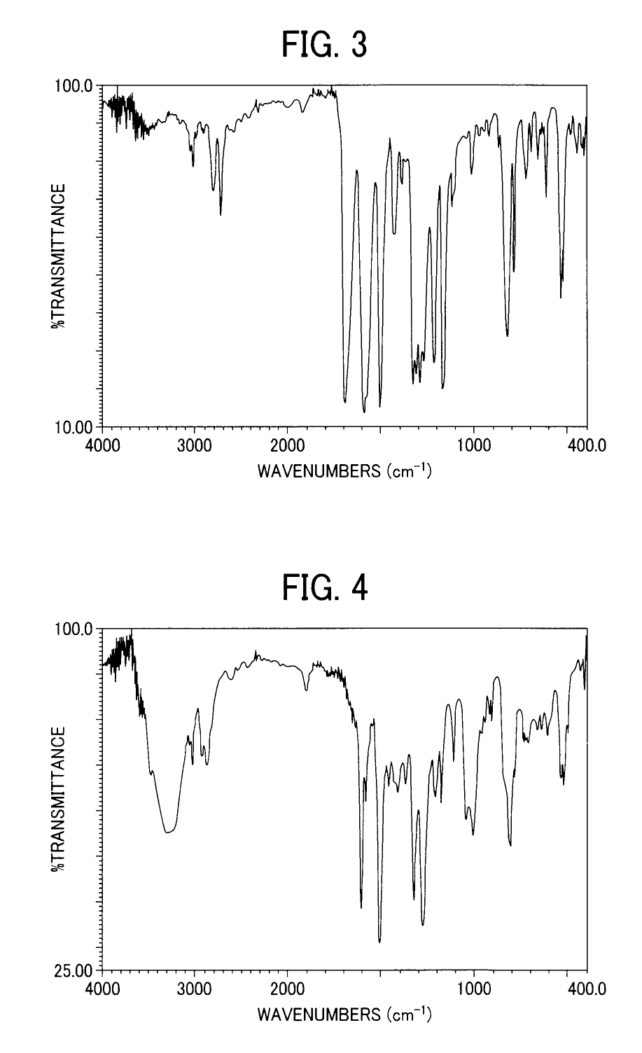

Place 30.16 g of the intermediate material, 71.36 g of N-methyl formanilide, and 400 ml of o-dichlorobenzene in a flask; Stir the mixture in argon gas atmosphere at room temperature; Drop 82.01 g of phosphorous oxychloride in the flask; Heat the system to 80° C. followed by stirring; Drop 32.71 g of zinc chloride in the flask; Stir the resultant at 80° C. for about ten hours and keep stirring at 120° C. for about three hours; Add potassium hydroxide aqueous solution to the flask to conduct hydrolysis reaction; Extract the resultant with dichloromethane followed by dehydration with magnesium sulfate and adsorption treatment by activated white earth; Filter, wash, and concentrate the resultant to obtain a crystal material; Refine the resultant with silica gel column (toluene/ethyl acetate:8/2) to isolate crystal; Re-crystallize the obtained crystal with methanol/ethyl acetate to obtain the target product (intermediate aldehyde compound) (yellow powder, yield: 27.80 g) The infra-red absorption spectrum graph is shown as FIG. 3.

### Synthesis of Illustrated Compound 2

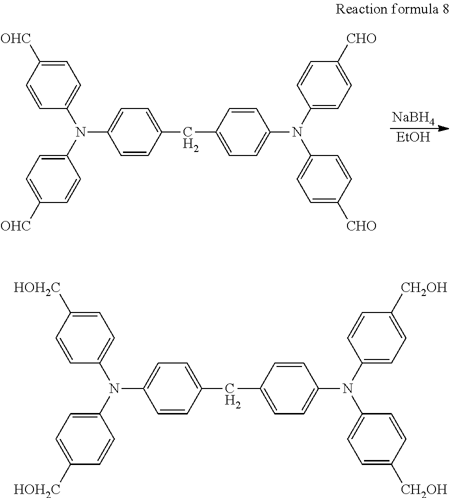

Place 12.30 g of the intermediate aldehyde compound and 150 ml of ethanol in a flask; Stir the mixture at room temperature and drop 3.63 g of hydrogenated boron sodium in the flask; Keep stirring the mixture for four hours; Extract the resultant with ethyl acetate followed by dehydration with magnesium sulfate and adsorption treatment by activated white earth and silica gel; Filter, wash, and concentrate the resultant to obtain an amorphous material; and Disperse the amorphous material in n-hexane followed by filtration, washing, and drying to obtain the target compound (illustrated compound 2) (pale yellow white amorphous, yield: 12.0 g). The infra-red absorption spectrum graph is shown as FIG. 4.

### Synthesis Example 3

### Synthesis of Illustrated Compound 3

### Synthesis of Manufacturing Intermediate Aldehyde Compound Material of Illustrated Compound 3

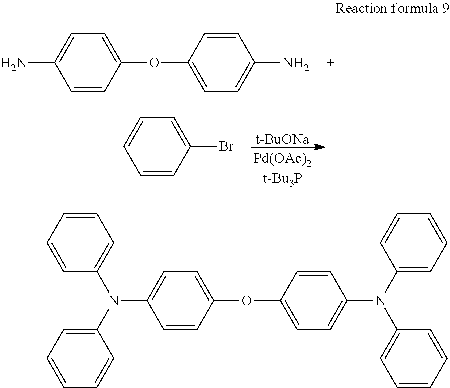

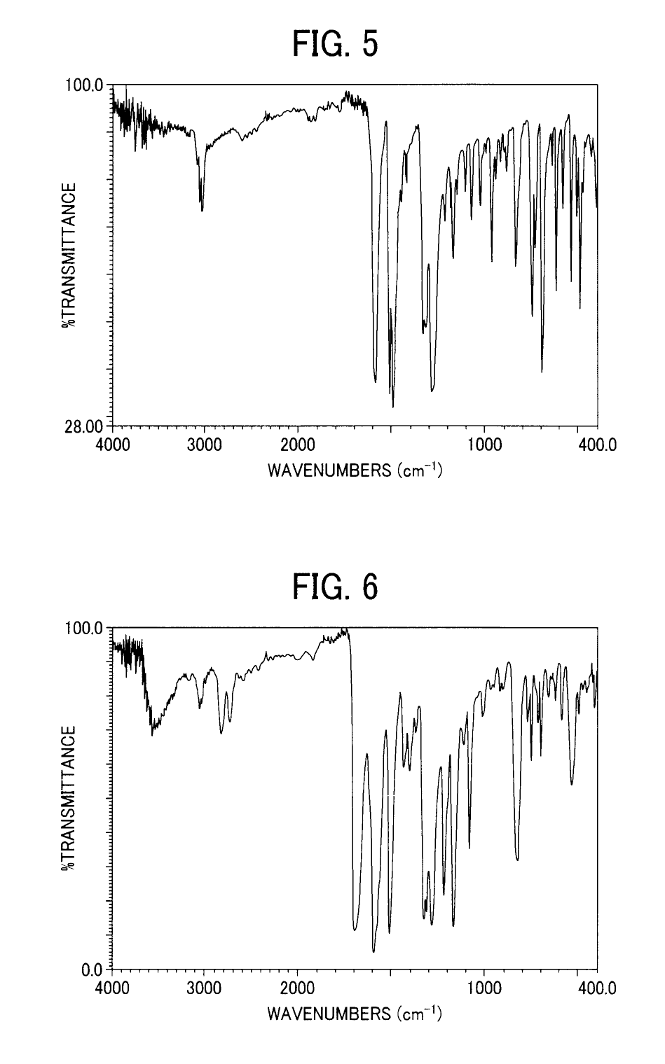

Place 20.02 g of 4,4′-diamino diphenyl ether, 69.08 g of bromobenzene, 0.56 g of paradium acetate, 46.13 g of tertial buthoxy sodium, and 250 ml of o-xylene in a flask; Stir the mixture in argon gas atmosphere at room temperature; Drop 2.02 g of tri-tertial butyl phosphine to the flask; Keep stirring at 80° C. for one hour and reflux the mixture for another one hour while stirring. Dilute the resultant with toluene and place magnesium sulfate, activated white earth, and silica gel in the flask followed by stirring; Filter, wash, and concentrate the resultant to obtain a crystal material; and Disperse the crystal in methanol followed by filtration, washing, and drying to obtain the target compound (intermediate material) (pale brown powder, yield: 43.13 g). The infra-red absorption spectrum graph is shown as FIG. 5.

### Synthesis of Manufacturing Intermediate Aldehyde Compound of Illustrated Compound 3

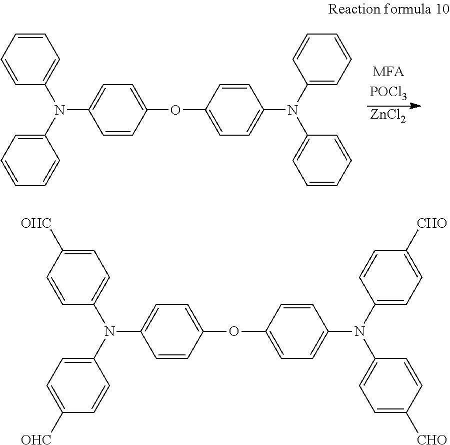

Place 30.27 g of the intermediate material, 71.36 g of N-methyl formanilide, and 300 ml of o-dichlorobenzene in a flask; Stir the mixture in argon gas atmosphere at room temperature; Drop 82.01 g of phosphorous oxychloride in the flask; Heat the system to 80° C. followed by stirring; Drop 16.36 g of zinc chloride in the flask; Stir the resultant at 80° C. for about one hour and keep stirring at 120° C. for four hours and at 140° C. for three hours; Add potassium hydroxide aqueous solution to the flask to conduct hydrolysis reaction; Extract the resultant using a toluene solvent and place magnesium sulfate followed by filtration, washing, and concentration; Conduct column refinement by toluene/ethyl acetate followed by concentration to obtain a crystal; Disperse the crystal in methanol followed by filtration, washing, and drying to obtain the target compound (intermediate aldehyde compound) (pale yellow powder, yield: 14.17 g). The infra-red absorption spectrum graph is shown as FIG. 6.

### Synthesis of Illustrated Compound 3

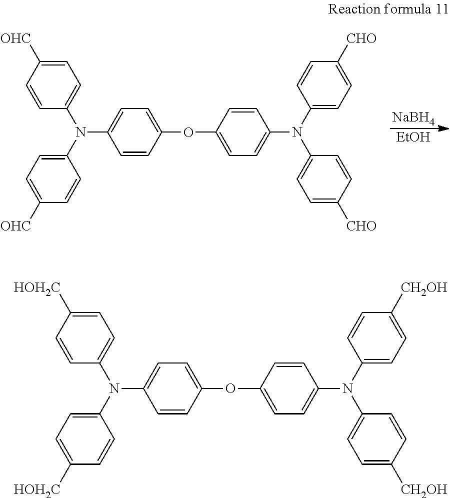

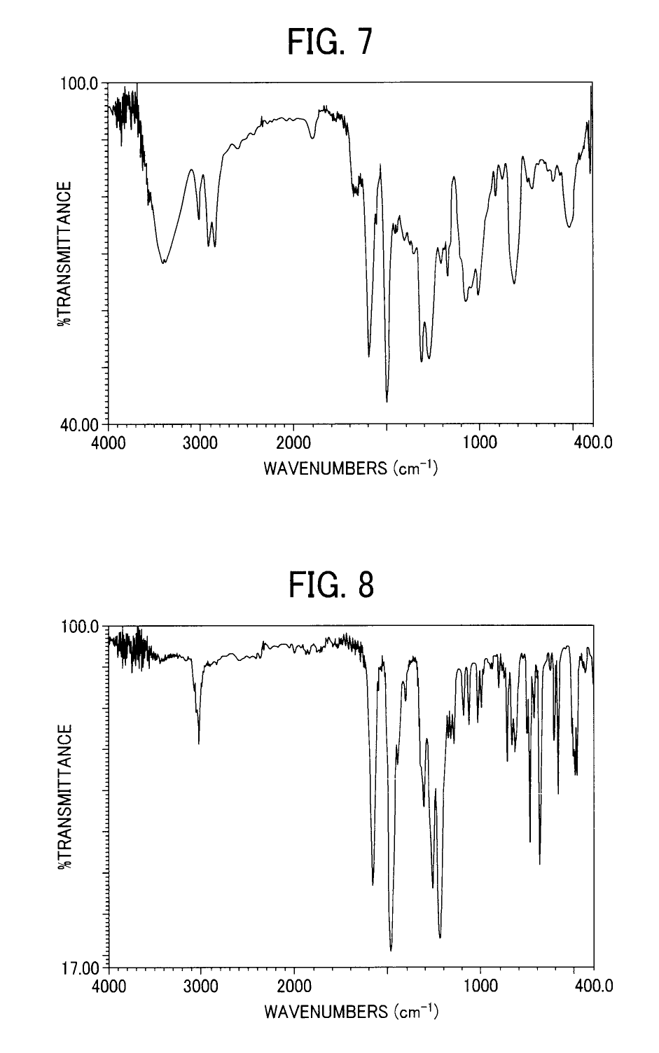

Place 6.14 g of the intermediate aldehyde compound and 75 ml of ethanol in a flask; Stir the mixture at room temperature and drop 1.82 g of hydrogenated boron sodium in the flask; Keep stirring the mixture for 7 hours; Extract the resultant with ethyl acetate followed by dehydration with magnesium sulfate and adsorption treatment by activated white earth and silica gel; Filter, wash, and concentrate the resultant to obtain an amorphous material; and Disperse the amorphous material in n-hexane followed by filtration, washing, and drying to obtain the target compound (illustrated compound 3) (white amorphous, yield: 5.25 g). The infra-red absorption spectrum graph is shown as FIG. 7.

### Synthesis Example 4

### Synthesis of Illustrated Compound 4

### Synthesis of Manufacturing Intermediate Aldehyde Compound Material of Illustrated Compound 4

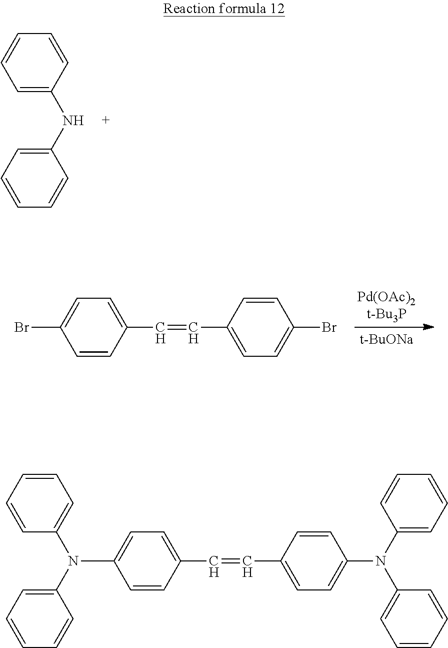

Place 22.33 g of diphenyl amine, 20.28 g of dibromostilbene, 0.336 g of paradium acetate, 13.84 g of tertial buthoxy sodium, and 150 ml of o-xylene in a flask; Stir the mixture in argon gas atmosphere at room temperature; Drop 1.22 g of tri-tertial butyl phosphine in the flask; Keep stirring at 80° C. for one hour and reflux the mixture for two hours while stirring. Dilute the resultant with toluene and place magnesium sulfate, activated white earth, and silica gel in the flask followed by stirring; Filter, wash, and concentrate the resultant to obtain a crystal material; and Disperse the crystal in methanol followed by filtration, washing, and drying to obtain the target compound (intermediate material) (yellow powder, yield: 29.7 g). The infra-red absorption spectrum graph is shown as FIG. 8.

### Synthesis of Manufacturing Intermediate Aldehyde Compound of Illustrated Compound 4

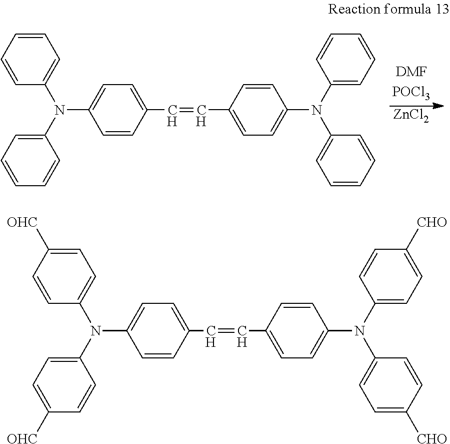

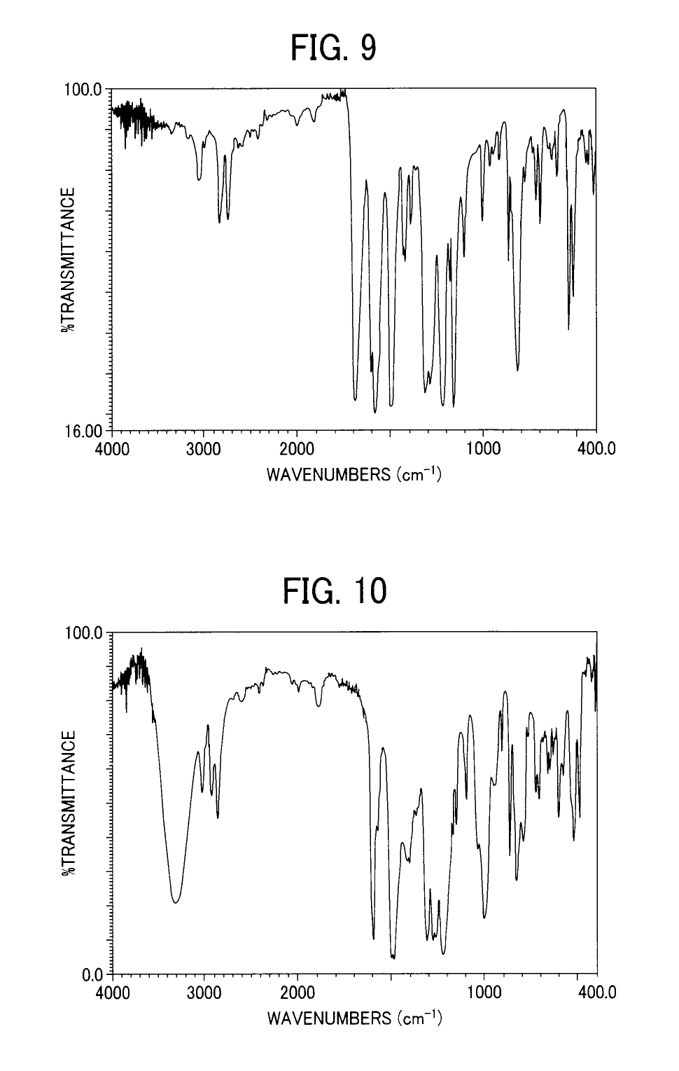

Place 33.44 g of dehydrated dimethyl aldehyde and 84.53 g of dehydrated toluene in a flask; Stir the mixture in argon gas atmosphere in ice water bath; Drop 63.8 g of phosphorous oxychloride slowly in the flask; Keep stirring the mixture for about one hour; Drop a solution in which 26.76 g of the intermediate material is dissolved in 106 g of dehydrated toluene solution in the flask slowly; Keep stirring at 80° C. for one hour and reflux the mixture for five hours while stirring; Add potassium hydroxide aqueous solution to the flask to conduct hydrolysis reaction; Extract the resultant with toluene followed by dehydration with magnesium sulfate followed by concentration; Refine the resultant with column (toluene/ethyl acetate:8/2) for isolation; Disperse the resultant in methanol followed by filtration, washing, and drying to obtain the target compound (intermediate aldehyde compound) (orange powder, yield: 16.66 g). The infra-red absorption spectrum graph is shown as FIG. 9.

### Synthesis of Illustrated Compound 4

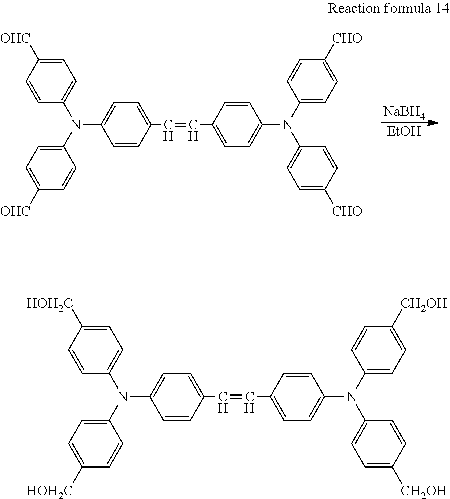

Place 6.54 g of the intermediate aldehyde compound and 75 ml of ethanol in a flask; Stir the mixture at room temperature and drop 1.82 g of hydrogenated boron sodium in the flask; Keep stirring the mixture for four hours; Extract the resultant with ethyl acetate followed by dehydration with magnesium sulfate and adsorption treatment by activated white earth and silica gel; Filter, wash, and concentrate the resultant to obtain an amorphous material; and Disperse the amorphous material in n-hexane followed by filtration, washing, and drying to obtain the target compound (illustrated compound 4) (yellow amorphous, yield: 2.30 g). The infra-red absorption spectrum graph is shown as FIG. 10.

### Synthesis Example 5

### Synthesis of Illustrated Compound 5

### Synthesis of Manufacturing Intermediate Aldehyde Compound Material of Illustrated Compound 5

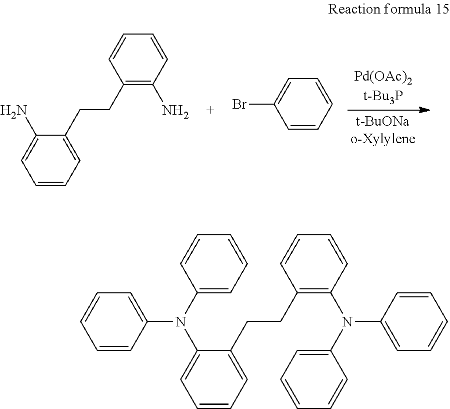

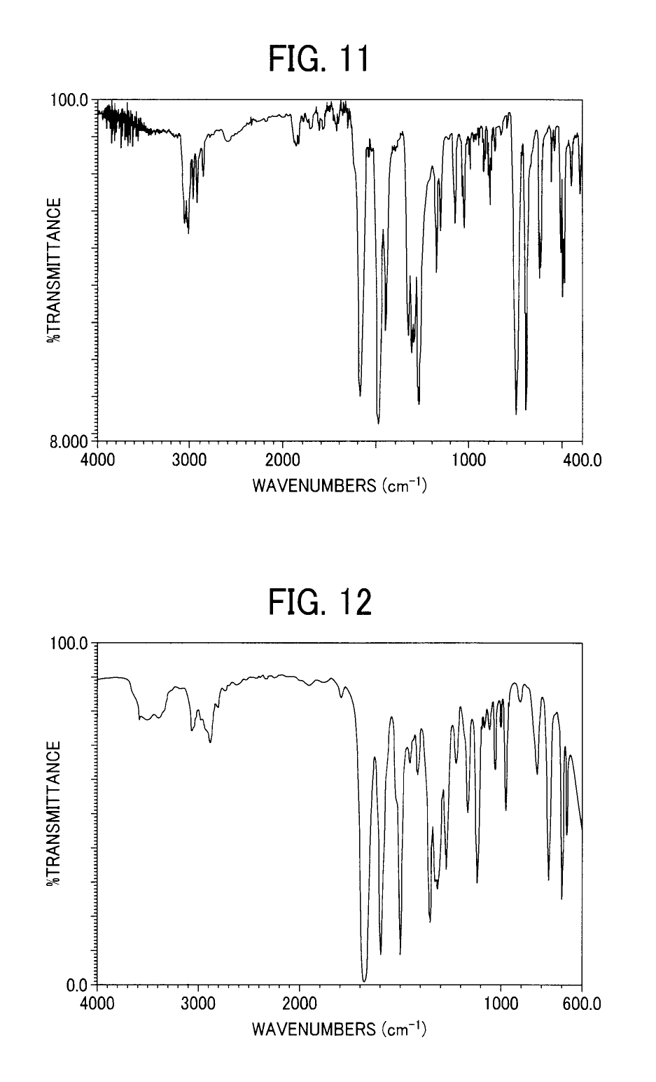

Place 21.33 g of 2,2′-ethylene dianiline, 75.36 g of bromobenzene, 0.56 g of paradium acetate, 46.13 g of tertial buthoxy sodium, and 250 ml of o-xylene in a flask; Stir the mixture in argon gas atmosphere at room temperature; Drop 2.03 g of tri-tertial butyl phosphine to the flask; Reflux the mixture for eight hours while stirring; Dilute the resultant with toluene and add magnesium sulfate and activated white earth in the flask followed by stirring at room temperature; Filter, wash, and concentrate the resultant to obtain a crystal material; Disperse the crystal in methanol followed by filtration, washing, and drying to obtain the target compound (intermediate material) (pale brown powder, yield: 47.65 g). The infra-red absorption spectrum graph is shown as FIG. 11.

### Synthesis of Manufacturing Intermediate Aldehyde Compound of Illustrated Compound 5

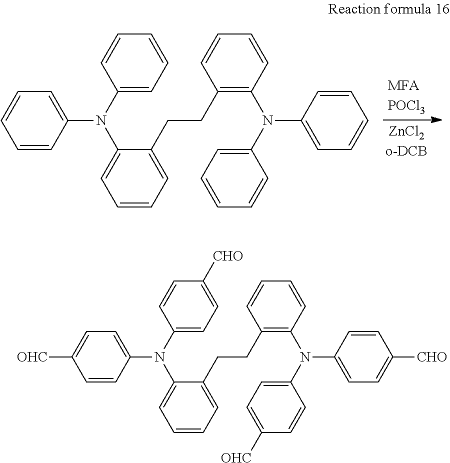

Place 31.0 g of the intermediate material, 71.36 g of N-methyl formanilide, and 400 ml of o-chlorobenzene in a flask; Stir the mixture in argon gas atmosphere at room temperature; Drop 82.01 g of phosphorous oxychloride slowly in the flask and heat the system to 80° C.; Add 32.71 g of zinc chloride to the resultant and keep stirring for one hour at 80° C. and about 24 hours at 120° C. Add potassium hydroxide aqueous solution to the flask to conduct hydrolysis reaction; Dilute the resultant with toluene, wash it with water, dehydrate the oil layer with magnesium chloride, and adsorb the resultant with activated white earth and silica gel followed by filtration, washing, and concentration to obtain the target product (intermediate aldehyde compound) (yellow liquid, yield: 22.33 g). The infra-red absorption spectrum graph is shown as FIG. 12.

### Synthesis of Illustrated Compound 5

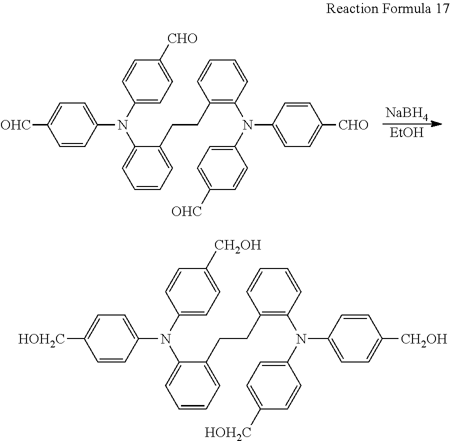

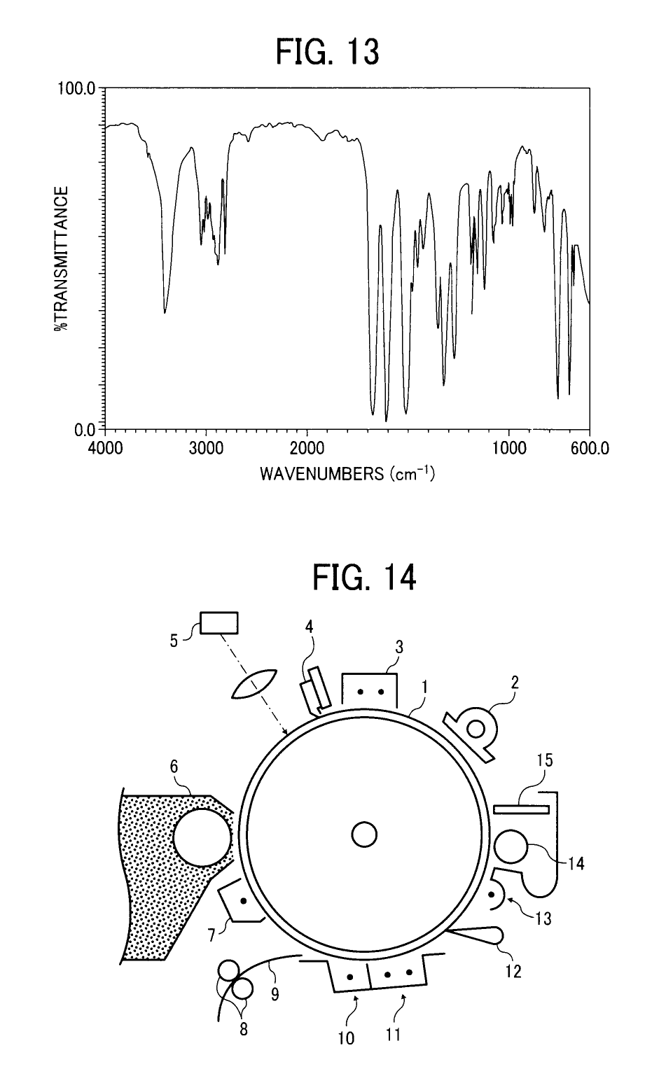

Place 9.43 g of the intermediate aldehyde compound and 100 ml of ethanol in a flask; Stir the mixture at room temperature and drop 2.72 g of hydrogenated boron sodium in the flask; Keep stirring the mixture for seven hours; Extract the resultant with ethyl acetate followed by dehydration with magnesium sulfate and adsorption treatment by activated white earth and silica gel; Filter, wash, and concentrate the resultant to obtain an amorphous material; and Disperse the amorphous material in n-hexane followed by filtration, washing, and drying to obtain the target compound (illustrated compound 5) (white amorphous, yield: 8.53 g). The infra-red absorption spectrum graph is shown as FIG. 13.

### Example 1

A liquid application of an undercoating layer having the following recipe, a liquid application of a charge generation layer having the following recipe, and the liquid application of a charge transport layer having the following recipe are applied to an aluminum cylinder having a diameter of 30 mm in that sequence followed by drying to form an undercoating layer having a thickness of 3.5 μm, a charge generation layer having a thickness of 0.2 μm, and a charge transport layer having a thickness of 18 μm.

A liquid application of a cross-linked type charge transport layer having the following recipe is spray-coated on the obtained charge transport layer and dried at 135° C. for 30 minutes to obtain a cross-linked type charge transport layer having a thickness of 5.0 μm. The image bearing member of Example 1 is thus manufactured.

### Recipe of Undercoating Layer

| | | |
|---|---|---|
| Alkyd resin (Beckozole 1307-60-EL, | 6 | parts |
| manufactured by Dainippon Ink and | | |
| Chemicals, Inc.): | | |
| Melamine resin (SuperBeckamine G-821-60, | 4 | parts |
| manufactured by Dainippon Ink and | | |
| Chemicals, Inc.): | | |
| Titanium oxide: | 40 | parts |
| Methylethylketone: | 50 | parts |

### Recipe of Liquid Application of Charge Generation Layer

| Polyvinyl butyral {XYHL, manufactured by | 0.5 | parts |
|---|---|---|
| Union Carbide Corporation (UCC)}: | | |
| Cyclohexanone: | 200 | parts |
| Methylethylketone: | 80 | parts |
| Bisazo pigment represented by the following chemical structure: | 2.4 | parts |

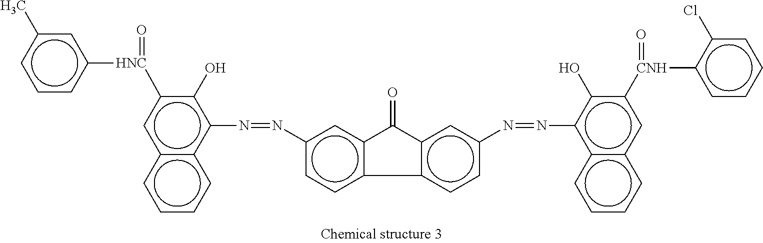

### Recipe of Liquid Application of Charge Transport Layer

| Bisphenol Z polycarbonate (PanLite TS-2050, | 10 | parts |
|---|---|---|
| manufactured by Teijin Chemicals Ltd.): | | |
| Tetrahydrofuran: | 100 | parts |
| Tetrahydrofuran solution having one weight % | 0.2 | parts |
| silicone oil (KF50-100CS, manufactured by | | |
| Shin-Etsu Chemical Co., Ltd.): | | |
| Charge transport material having a low molecular weight | 7 | parts |

represented by the following chemical structure 4:

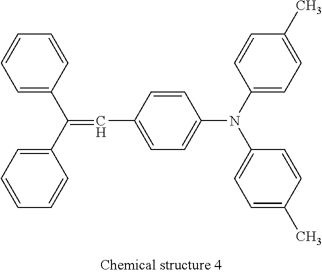

### Recipe of Liquid Application of Cross-Linked Type Charge Transport Layer

| | | |
|---|---|---|
| Illustrated compound No. 1: | 20 | parts |
| Paratoluene sulfate: | 0.02 | parts |
| Tetrahydrofuran: | 100 | parts |

### Example 2

The image bearing member of Example 2 is manufactured in the same manner as in Example 1 except that the illustrated compound 1 is changed to the illustrated compound 2.

### Example 3

The image bearing member of Example 3 is manufactured in the same manner as in Example 1 except that the illustrated compound 1 is changed to the illustrated compound 3.

### Example 4

The image bearing member of Example 4 is manufactured in the same manner as in Example 1 except that the illustrated compound 1 is changed to the illustrated compound 4.

### Example 5

The image bearing member of Example 5 is manufactured in the same manner as in Example 1 except that the illustrated compound 1 is changed to the illustrated compound 5.

### Comparative Example 1

The image bearing member of Comparative Example 1 is manufactured in the same manner as in Example 1 except that the illustrated compound 1 is changed to the following compound represented by the chemical structure 5.

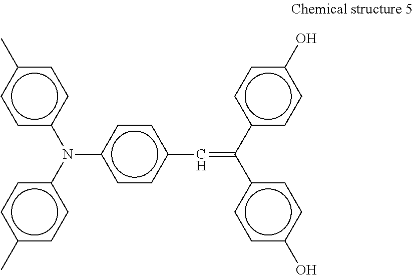

### Comparative Example 2

The image bearing member of Comparative Example 1 is manufactured in the same manner as in Example 1 except that the illustrated compound 1 is changed to the following compound represented by the chemical structure 6.

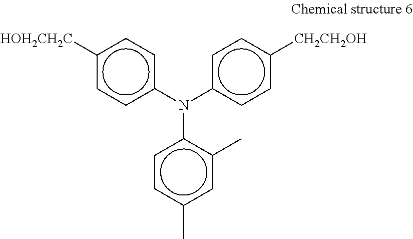

### Measuring of Gel Fraction of Cross-Linked Type Charge Transport Layer

The gel fraction of cross-linked type charge transport layer is obtained as follows: The gel fraction is obtained by measuring the weight remaining ratio of the gel by directly applying a liquid application of the cross-linked type charge transport layer to an aluminum cylinder as in Examples 1 to 5 and Comparative Examples 1 and 2, drying the formed layer by heat, and dipping the layer in tetrahydrofuran solution at 25° C. for five days and assigning the measuring result in the following relationship 1.

The results are shown in Table 1.

Gel fraction (%)=100×(weight of cured material after dipping and drying/original weight of cured material) Relationship 1

TABLE 1

| | Compound | Gel fraction (%) |
|---|---|---|
| Example 1 | Illustrated compound no. 1 | 97 |
| Example 2 | Illustrated compound no. 2 | 96 |
| Example 3 | Illustrated compound no. 3 | 98 |
| Example 4 | Illustrated compound no. 4 | 97 |
| Example 5 | Illustrated compound no. 5 | 97 |
| Comparative | Compound of Chemical | 68 |
| Example 1 | structure 5 | |
| Comparative | Compound of Chemical | 0 |
| Example 2 | structure 6 | |

### Actual Machine Test

Next, images are formed on 300,000 sheets having an A4 size using the respective image bearing members of Examples 1 to 5 and Comparative Examples 1 and 2 and toner (having a volume average particle diameter of 9.5 μm, an average circularity of 0.91) containing silica (external additive) as follows.

The respective image bearing members are set in a process cartridge, which is attached to an image forming apparatus remodeled based on imagio Neo 270 (manufactured by Ricoh Co., Ltd.) having a semi-conductor laser that emits a light beam having a wavelength of 655 nm as the image irradiation light source, and images are continuously formed on 300,000 sheets in total with a voltage at a dark portion of 900 (−V). The initial image and the image printed after the 300,000 image printing are evaluated.

In addition, for the initial state and after the 300,000 image printing, the voltage at a bright portion is measured where the quantity of light of the image irradiation light source is about 0.4 μJ/cm. Furthermore, the image bearing members are evaluated with regard to the layer thickness difference between the initial stage and after the 300,000 images are printed. In addition, observe the image printed after the 300,000 images are printed and count the number of white mottles per unit of area in the solid image portion.

The results are shown in Table 2.

TABLE 2

| | | Initial | | | | | |
|---|---|---|---|---|---|---|---|
| | | Voltage at | | Voltage at | | Abrasion | Number of |
| | | bright | Image | bright | Image | amount | white mottles |
| | Compound | portion | quality | portion | quality | (μm) | (mottles/100 cm²) |
| Ex. 1 | Illustrated | 84 | Good | 98 | Good | 1.4 | 0 to 5 |
| | compound | | | | | | |
| | no. 1 | | | | | | |
| Ex. 2 | Illustrated | 78 | Good | 87 | Good | 1.2 | 0 to 5 |
| | compound | | | | | | |
| | no. 2 | | | | | | |
| Ex. 3 | Illustrated | 81 | Good | 89 | Good | 1.5 | 0 to 5 |
| | compound | | | | | | |
| | no. 3 | | | | | | |
| Ex. 4 | Illustrated | 68 | Good | 79 | Good | 1.4 | 0 to 5 |
| | compound | | | | | | |
| | no. 4 | | | | | | |
| Ex. 5 | Illustrated | 74 | Good | 84 | Good | 1.3 | 0 to 5 |
| | compound | | | | | | |
| | no. 5 | | | | | | |
| Comp. 1 | Compound of | 75 | Good | 256 | Greatly | 9 | 0 to 5 |
| | Chemical | | | | degraded | | |
| | structure 5 | | | | | | |
| Comp. 2 | Compound of | 58 | Good | 124 | Degraded | 15 | 0 to 5 |
| | Chemical | | | | | | |
| | structure 6 | | | | | | |

As seen in the results shown in Table 2, the image bearing members of Examples 1 to 5 have a markedly excellent durability among organic photoconductors having an excellent durability and are capable of producing imaged with few defects. In particular, a problem of white mottles caused by silica sticking in the surface of an image bearing member, which is ascribable to improvement on the durability of the image bearing member, thereby preventing scraping of the surface of the image bearing member, hardly occurs so that the image bearing members of Examples 1 to 5 can produce quality images for an extended period of time.

Although cross-linked structures are formed in the image bearing members of Comparative Examples 1 and 2, the number of arms of the network structure is small so that the durability thereof is inferior.

Since the durability is inferior, silica stuck in the surface is scraped together so that no white mottles are observed in the images. However, abrasion after the 300,000 image printing is severe, thereby increasing the voltage at a bright portion. Therefore, the image density significantly decreases.

This document claims priority and contains subject matter related to Japanese Patent Application No. 2010-163847, filed on Jul. 21, 2010, the entire contents of which are hereby incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image bearing member comprising:
a substrate; and
a layer provided overlying the substrate, the layer comprising a cured material in which a compound comprising three or more methylol groups and a charge transport group is cross-linked.

2. The image bearing member according to claim 1, wherein the compound is 4,4′,4″-trimethylo triphenyl amine represented by the following chemical structure 1.

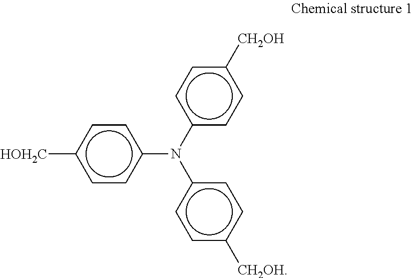

3. The image bearing member according to claim 1, wherein the compound is represented by the following chemical structure 2; 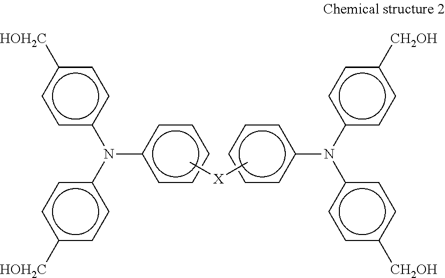
where X represents —O—, —CH₂—, —CH═CH—, and —CH₂CH₂—.

4. The image bearing member according to claim 1, wherein the layer forms an uppermost surface layer of the image bearing member.

5. The image bearing member according to claim 1, further comprising a charge generation layer, a charge transport layer, and a cross-linked type charge transport layer formed on the substrate in that sequence,
wherein the cross-linked type charge transport layer forms an uppermost surface layer of the image bearing member.

6. An image forming method comprising:
charging a surface of the image bearing member of claim 1;
irradiating the surface of the image bearing member with light to form a latent electrostatic image thereon;
developing the latent electrostatic image with a development agent comprising toner to obtain a visual image;
transferring the visual image to a recording medium; and
fixing the visual image on the recording medium.

7. An image forming apparatus comprising:
the image bearing member of claim 1;
a charger to charge a surface of the image bearing member;
an irradiator to irradiate the surface of the image bearing member with light to form a latent electrostatic image thereon;
a development device to develop the latent electrostatic image with a development agent comprising toner to obtain a visual image;
a transfer device to transfer the visual image to a recording medium; and
a fixing device to fix the visual image on the recording medium.

8. A process cartridge comprising:
the image bearing member of claim 1; and
at least one device selected from the group consisting of a charger, an irradiator, a development agent, a transfer device, a cleaning device, and a discharging device,
wherein the process cartridge is detachably attachable to an image forming apparatus.
